(19) United States
(12) Patent Application Publication
(10) Pub. No.: US 2016/0133133 A1
(43) Pub. Date: May 12, 2016

(54) Vehicle-Parking Services

(71) Applicant: Mark Triplett, St. Charles, IL (US)

(72) Inventor: Mark Triplett, St. Charles, IL (US)

(21) Appl. No.: 14/934,965

(22) Filed: Nov. 6, 2015

Related U.S. Application Data
(60) Provisional application No. 62/076,962, filed on Nov. 7, 2014.
(60) Provisional application No. 62/138,091, filed on Mar. 25, 2015.

(51) Int. Cl. G08G 1/137; G08G 1/14

(52) U.S. Cl. CPC G08G 1/137; G08G 1/14

(57) ABSTRACT

Embodiments provided herein are related to providing vehicle-parking services and, more particularly, to methods, systems, computer-readable medium, services, and/or apparatuses that facilitate valet parking and/or self-parking or some aspects thereof.

### CROSS-REFERENCE TO RELATED APPLICATIONS

This application claims priority to U.S. Provisional Patent Application No. 62/076,962, filed on Nov. 7, 2014, entitled Systems and Methods for Parking Vehicles, and U.S. Provisional Patent Application No. 62/138,091, filed on Mar. 25, 2015, entitled Methods, Systems, Platforms, and Apparatuses that Facilitate Valet Parking, each of which is incorporated by reference in its entirety.

### FIELD OF DISCLOSURE

The disclosure is related to technology that can be used to provide vehicle-parking services and, more particularly, to methods, systems, platforms, products, computer-readable medium, services, and/or apparatuses that facilitate valet parking and/or self-parking or some aspect thereof.

### BACKGROUND

Businesses such as restaurants, malls, hotels, airports, casinos, country clubs, and other establishments may offer vehicle-parking services, such as valet parking. In contrast to “self-parking,” where a driver parks a vehicle on his or her own, “valet parking” is a service where a parking attendant parks a driver's vehicle for the driver.

Commonly, a valet-parking setup may include a valet stand, a key box for storing and protecting vehicle keys, and paper tickets or stubs that may be used to identify the vehicle to which given keys correspond (e.g., via a ticket number or the like). Some valet-parking services may also utilize other items to inform or otherwise direct customers (e.g., vehicle drivers), such as specially designed umbrellas, signs, or other visualizations that are used to direct customers toward the valet service and/or display prices for the service.

Generally, parking options such as valet-parking and self-parking are manual in nature and may be cumbersome. For instance, in a typical valet service, when a vehicle is dropped off at a valet stand, the valet attendant provides the driver of the vehicle with a paper (e.g., cardboard) ticket or stub that includes a ticket number. The driver then stores the paper ticket somewhere, such as in a pocket, wallet, or purse, in hopes of not losing the ticket.

When the driver is ready to retrieve the vehicle, for instance, the driver would walk to the valet stand (most often located outdoors), find a valet attendant (assuming one is around), and hand the paper ticket to the valet attendant (assuming the driver did not lose the ticket). The driver might also pay the attendant at this time, most often with cash.

While the driver waits for the vehicle, oftentimes by standing near the valet stand even in inclement weather, the valet attendant would then locate the keys corresponding to the ticket number from the driver's paper ticket and then locate the vehicle corresponding to the keys. Once the attendant arrives with the driver's vehicle, the driver may pay the attendant a tip (e.g., in cash) and finally drive off.

Using a paper ticket presents numerous problems including, but not limited to, retrieving a vehicle when a driver loses the paper ticket and/or a driver waiting at the valet stand while the vehicle is retrieved. Furthermore, the customary practice is for drivers to tip the valet attendant (e.g., with cash), which presents a problem to drivers that do not carry cash. Other problems and issues also occur. To say the least, the valet service experience may be an undesirable one for drivers, which in turn may reflect poorly on the establishment at which the valet service is provided. This result may be unfortunate for the establishment, especially considering the effort that most likely went into creating a positive experience for the driver inside the restaurant or other establishment.

Somewhat similarly, in a typical self-parking service, when a vehicle enters a parking lot, the driver may take a paper ticket. The driver then uses the paper ticket upon exiting the parking lot to determine how much he or she must pay for the time parked in the parking lot. Again, using a paper ticket presents numerous problems including, but not limited to, exiting the parking lot when the driver loses the paper ticket and/or paying exorbitant parking fees for remaining in the lot over the initially intended amount of time. Furthermore, paying parking fees often requires manual transaction with an attendant and/or paying the fee at a kiosk located in an area away from where the vehicle is parked.

### BRIEF DESCRIPTION OF THE DRAWINGS

Features, aspects, and advantages of the disclosed technology may be better understood with regard to the following description, appended claims, and accompanying drawings where:

FIG. 1A shows an example network configuration in which one or more embodiments disclosed herein may be practiced or implemented;

FIG. 1B shows a conceptual illustration of example signal flow between components of the network configuration of FIG. 1A;

FIG. 1C shows a simplified block diagram of an example networked computing device;

FIG. 2A shows an example method of some VPS-related operations;

FIG. 2B shows an example method of some VPS-related operations for retrieving a vehicle parked with a VPS;

FIG. 3 shows a conceptual illustration of certain aspects of the operation of a VPS;

FIG. 4 shows an example method of some vehicle check-in operations;

FIGS. 5A, 5B, and 5C show example graphical user interfaces that include queues as displayed on a VPS device;

FIG. 6 shows an example of an in-lot queue as displayed on a VPS device;

FIG. 7 shows an example queue of requested vehicles as displayed on a VPS device;

FIG. 8 shows an example queue of completed vehicles as displayed on a VPS device;

FIG. 9 shows an example a graphical user interface of a VPS management tool as displayed on a VPS device;

FIG. 10 shows another example graphical user interface of a VPS management tool as displayed on a VPS device;

FIG. 11 shows various graphical user interfaces that a driver device might display when running a VPS application;

FIG. 12 shows a screenshot of a graphical user interface that a driver device might display when running a VPS application;

FIG. 13 shows a graphical user interface that a driver device might display after the driver has requested his or her vehicle;

FIG. 14 shows a graphical user interface that a driver device might display after the driver's vehicle has been returned to the driver;

FIG. 15 shows another screenshot of a graphical user interface that a driver device might display when running a VPS application;

FIG. 16A shows various screenshots of a graphical user interface that may be displayed on a driver device as a driver registers a paper ticket;

FIGS. 16B, 16C, 16D, 16E, 16F, and 16G show another series of screenshots of a graphical user interface that may be displayed on a driver device as a driver registers a paper ticket;

FIG. 17 shows an example check-in confirmation that may be displayed by a driver device;

FIG. 18 shows a screenshot of a graphical user interface that may facilitate electronic vehicle requests and payment;

FIG. 19 shows another screenshot of a graphical user interface that may be displayed by a driver device;

FIG. 20 shows yet another screenshot of a graphical user interface that may be displayed by a driver device;

FIG. 21 shows an example screenshot of a display shown on a driver device after the driver's vehicle is checked in; and

FIGS. 22A and 22B show example screenshots of a graphical user interface of a driver device in accordance with an embodiment.

### DETAILED DESCRIPTION

### I. Overview

Examples discussed herein relate to technology that facilitates providing a vehicle-parking service (“VPS”). By way of illustration, aspects of the technology may be used by one or more parking attendants, drivers of vehicles, establishments, automobile manufacturers, and/or other entities. There are numerous inventions described herein as would be understood by one of ordinary skill in the art upon reading this description.

As noted above, the VPS experience has remained the same, or nearly the same, for many years from the perspective of customers (e.g., drivers) and the individuals providing the service (e.g., parking attendants). This traditional experience has several drawbacks, which become even more pronounced when, for example, a driver has an enjoyable experience within a restaurant (e.g., a nice atmosphere, friendly service, good food, and so on) that unpleasantly ends at the door when the driver is then left to deal with the inconvenience of picking up his or her vehicle curbside using a traditional VPS. This experience quickly worsens when the weather is cold or raining, the paper parking ticket is lost, the driver does not have cash to leave the attendant a tip, etc.

Use of the VPS technology described herein, however, may help to improve the overall experience for the driver (and his or her passengers). For instance, (1) the driver may no longer need to deal with a paper parking ticket, (2) if the driver does initially take a paper parking ticket, the driver has the option to convert the paper ticket to an electronic ticket at a later time, (3) the driver can electronically pay for the parking service at the driver's convenience (e.g., while inside a restaurant), (4) the driver can request pick-up of his or her vehicle at the driver's convenience (e.g., while inside a hotel lobby), and (5) the driver may be notified of VPSs nearby as he or she is driving. Other driver advantages will become apparent in reading the below disclosure.

Moreover, use of the VPS technology described herein may help to improve the overall experience of a VPS generally. For instance, (1) parking attendants may no longer need to provide paper parking tickets to drivers, (2) parking attendants may be provided information about a soon-to-arrive driver that allows the attendants to, for example, greet drivers by their respective names, (3) parking attendants may no longer need to make cash transactions, (4) drivers no longer need to congregate around a parking stand, and (5) a VPS may be remotely monitored and/or managed. Other advantages will become apparent in reading the below disclosure.

In example embodiments, a VPS system may be utilized to facilitate providing VPSs, such as valet-parking services. A given VPS system may be affiliated with one or multiple establishments or the like that offer, provide, or are otherwise associated with a VPS. By way of illustration, an establishment might take the form of a restaurant that offers a VPS for its customers; the VPS might be operated independently of the restaurant, or the VPS might be operated by the restaurant itself.

Generally, a VPS system may include one or more remote computing systems (e.g., servers) that communicate via a communication network to one or more networked devices of a VPS (e.g., mobile computing devices operated by parking attendants). The VPS system may include additional and/or other devices and/or systems as described herein.

In an embodiment, while a driver is driving his or her vehicle, a networked device of the driver (“driver device”) sends a message directly or indirectly to notify a nearby VPS that the networked device (and thus the driver and vehicle) is within a threshold proximity of the VPS. The notification message, or a subsequent message sent by the networked device, may contain information that identifies the driver and/or the driver's vehicle. In practice, the notification message, or a subsequent message, may include various other information pertaining to the driver, such as credit card information or information for some other electronic payment mechanism, and/or vehicle.

In example embodiments, the driver device described above may take the form of a mobile computing device, which may be carried by the driver. Examples of mobile computing devices include smartphones, tablets, wearable computing devices (e.g., smart watches, head-mountable devices, etc.) and other networked-enabled, mobile devices. In an alternative embodiment, the driver device may be part of the driver's vehicle itself. In this alternative embodiment, the driver device may include or take the form of a vehicle module that is configured to send one or more messages to a VPS that is nearby the vehicle. In practice, the vehicle module may be built into the vehicle, attached on, or located inside the vehicle. In some embodiments, the vehicle module may also be used, if so programmed, to perform other operations, such as pay a roadway toll, for instance.

In example embodiments, a networked device of a VPS (“VPS device”) may be notified that a particular driver is within a threshold proximity of the location of the VPS. The notification message, or a subsequent message, received by the VPS device may contain information that identifies the driver and the driver's vehicle.

In an embodiment, the VPS device described above may take the form of a mobile computing device, such as any of the mobile computing devices discussed above. In an example where the VPS is a valet service, the mobile device may be left at, or near, the valet stand, or the mobile device may be carried with a valet attendant. In practice, more than one VPS device may be used by the VPS.

In example embodiments, additionally or alternatively, a networked computing device of an establishment (“establishment device”) or some other device inside the establishment is configured to receive a notification that a registered driver is within a threshold proximity of the VPS associated with the establishment. By way of illustration, a networked device at a hostess stand at a restaurant may be configured to alert the hostess that a certain party is arriving. In another illustration, a reservation service like OpenTable Inc. (“OpenTable”) or Yelp SeatMe (OpenTable and Yelp SeatMe provide online tools to make reservations via the Internet; e.g., www.opentable.com and www.seatme.yelp.com) may have a computer located inside an establishment that is configured to receive driver notifications. Other examples of establishment devices are also possible.

In any event, based on receipt of a notification, the establishment device may, for instance, indicate via a graphical interface that a party is arriving and perform additional operations, such as mark the party's reservation as being in progress or completed. In some embodiments, the establishment device may further provide the hostess, via the graphical interface, an indication of an appropriate table for the party based on various considerations, such as the party's arrival time, the party size from the party's reservation, and a current state of tables in use at that time.

In example embodiments, messages are sent between networked devices, such as between a driver device, a VPS device, and/or an establishment device. In practice, a given message may be transmitted directly between multiple devices, such as using a wireless network protocol, or a given message may be transmitted indirectly between multiple devices using one or more intermediary devices, like a server, using a different kind of wireless network protocol. In some embodiments, a combination of protocols may be used to exchange messages and/or obtain information from remote sources.

In example embodiments, the technology described herein may help allow for vehicle parking without the need for paper tickets. For instance, the VPS system may be configured to issue an electronic ticket to a driver device of a given driver. The electronic ticket may include a ticket identifier (e.g., a number) that associates the driver device to the corresponding driver and/or vehicle. This process may be done without requiring intervention from the driver, perhaps without the driver knowing that he or she has been issued an electronic ticket (e.g., the driver device may receive the electronic ticket without the driver interacting with the driver device). Thereafter, the driver has access to the ticket number via his or her driver device, and the VPS has access to the ticket number via the VPS device.

Continuing on further with the embodiment where the electronic ticket has been issued, in some embodiments, the driver can now request his or her vehicle using the driver device, such as while the driver is finishing his or her meal within the establishment. The driver may also utilize the driver device to pay for the VPS and even pay a tip using an electronic payment method.

In example embodiments, the technology described herein may help allow a driver that receives a paper ticket from a parking attendant to convert the paper ticket to an electronic ticket (e.g., in a scenario where the driver is not yet registered with the VPS system). Once the paper ticket is converted to an electronic ticket, the driver can request the vehicle and pay as if an electronic ticket was issued in the first instance.

In practice, the driver device may facilitate converting the paper ticket to an electronic ticket by way of capturing a photographic image of the paper ticket. The image may then be sent from the driver device to a VPS server, which may then transmit to a VPS device the image of the paper ticket or some indication thereof. In some embodiments, after the VPS server receives the image from the driver device, the VPS server generates an electronic ticket (perhaps with a ticket number that differs from that of the paper ticket) and transmits the electronic ticket to the driver device and/or VPS device. The driver may then use the electronic ticket to establish proof that the driver corresponds to the vehicle (e.g., before a parking attendant actually hands off the vehicle to the driver).

As suggested above, in example embodiments, an electronic ticket is utilized for parking a given vehicle. The electronic ticket may include an indicator that associates a vehicle to a driver and/or driver device. In practice, the electronic ticket may be generated by a VPS server, or perhaps by the VPS device. Other examples are also possible.

In an illustrative example, a driver (e.g. “Jack) downloads to his mobile device a VPS software application (“app”), such as a “Hiker” app, which is currently owned by Hiker Valet, LLC, Jack then registers to utilize the technology described herein. In practice, registration may involve Jack creating a user profile (also referred to herein as a “driver profile”) that includes details about himself, his vehicle, and electronic payment information, among other information. Jack's user profile may then be stored in a VPS server.

Sometime after registration, Jack may make a reservation, for example, via OpenTable, at the General Restaurant at 7 PM on a particular date. On that particular date, before arriving at the General Restaurant, Jack may open the Hiker app on his mobile device and cause the app to operate in the background.

As Jack's vehicle approaches the General Restaurant, Jack's mobile device may communicate (e.g., directly or indirectly) with a VPS system associated with the General Restaurant. Based on this communication, the VPS system may determine that Jack's mobile device (and his vehicle) is nearby the location of the VPS (e.g., GPS coordinates of a valet stand or location of a given VPS device) associated with the General Restaurant. In example embodiments, Jack may be considered nearby the VPS when Jack is within a predetermined distance from the VPS, such as at least within 200 ft., though the distance could be more or less depending on how the VPS system is configured. After the VPS system makes the determination, the VPS system may then notify a parking attendant of Jack's imminent arrival (e.g., via a graphical interface of a VPS device).

Additionally, the VPS system may facilitate checking in Jack and/or his vehicle at the parking-attendant stand (e.g., valet stand). For example, the parking attendant may use the graphical interface of a VPS device to check Jack and his vehicle in (e.g., by touching an icon, button, or the like that represents Jack). The process of checking Jack in may include the VPS system transmitting an electronic ticket to Jack's mobile device. In this example, Jack does not need to receive a paper ticket from the parking attendant or even interact with his mobile device to receive his electronic parking ticket. Moreover, the parking attendant may be able to greet Jack (e.g., “Hello Jack”) because the attendant knows the identity of Jack based on Jack's profile and other information available to the attendant via the VPS system.

When Jack is done with his dinner at the General Restaurant, or any time he needs his vehicle, he may use his mobile device to send a request to the VPS system (e.g., while still sitting at the table) to request his vehicle and/or pay for the VPS and tip the attendant using an electronic account (e.g., credit card). Many other example illustrations are provided herein.

As discussed, embodiments disclosed herein are related to vehicle-parking technology. In one aspect, a computing system is provided that comprises (i) a network interface configured to facilitate wireless communication with a computing device associated with a vehicle, (ii) one or more processors, (iii) a non-transitory computer-readable medium, and (iv) program instructions stored on the non-transitory computer-readable medium that are executable by the one or more processors to cause the computing system to: (a) determine that the computing device associated with the vehicle is within a threshold proximity of a vehicle-parking service, (b) based at least on the determining, add a vehicle identifier corresponding to the computing device associated with the vehicle to a parking queue, wherein the parking queue comprises one or more vehicle identifiers corresponding to respective vehicles that are to be parked via the vehicle-parking service, (c) transmit, via the network interface to a computing device of the vehicle-parking service, data representing the parking queue, and (d) based on receiving an indication that the vehicle has been parked, remove the vehicle identifier from the parking queue.

In another aspect, a computing device of a vehicle-parking service is provided, where the computing device comprises (i) at least one network interface, wherein the at least one network interface is configured to facilitate wireless communication with a computing system associated with the vehicle-parking service, (ii) a graphical user interface, (iii) one or more processors, (iv) a non-transitory computer-readable medium, and (v) program instructions stored on the non-transitory computer-readable medium that are executable by the one or more processors to cause the computing device to: (a) determine that a computing device associated with a vehicle is within proximity of the vehicle-parking service, (b) cause the graphical user interface to display a graphical indicator corresponding to the vehicle, and (c) based on detecting, via the graphical user interface, a selection of the graphical indicator, transmit to the computing system an indication that the vehicle has been parked.

In yet another aspect, a non-transitory computer-readable medium is provided that comprises program instructions stored thereon that are executable to cause a computing system to: (a) determine that a computing device associated with a vehicle is within a threshold proximity of a vehicle-parking service, (b) based at least on the determining, add a vehicle identifier corresponding to the computing device associated with the vehicle to a parking queue, wherein the parking queue comprises one or more vehicle identifiers corresponding to respective vehicles that are to be parked via the vehicle-parking service, (c) transmit, via a network interface to a computing device of the vehicle-parking service, data representing the parking queue, and (d) based on receiving an indication that the vehicle has been parked, remove the vehicle identifier from the parking queue.

Various other aspects are also provided herein, such as computer-implemented methods, other computing devices, other computing systems, and/or other computer-readable media, among other examples.

### II. Example Network Configuration

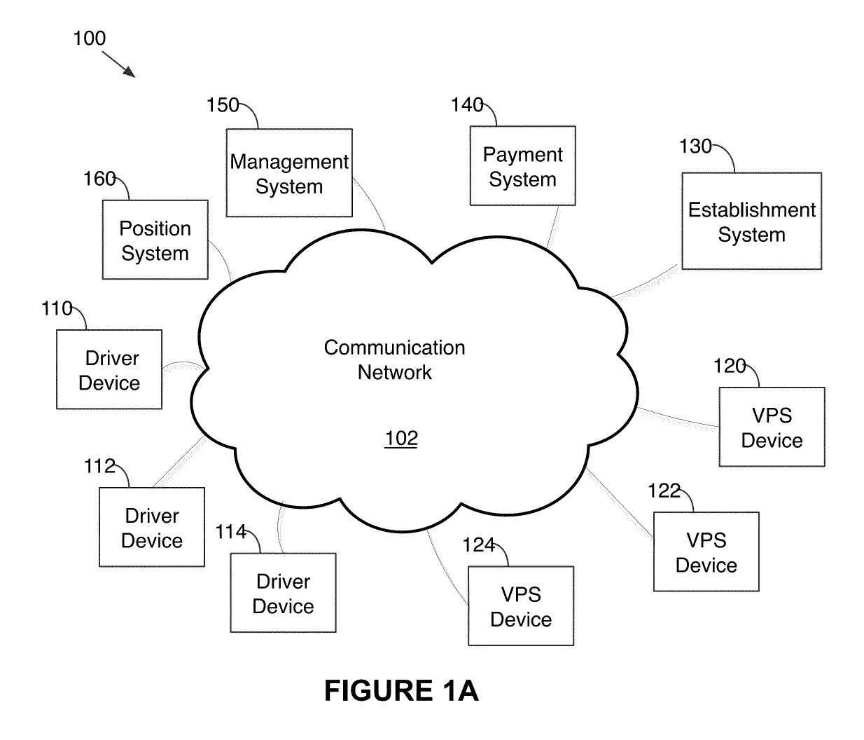

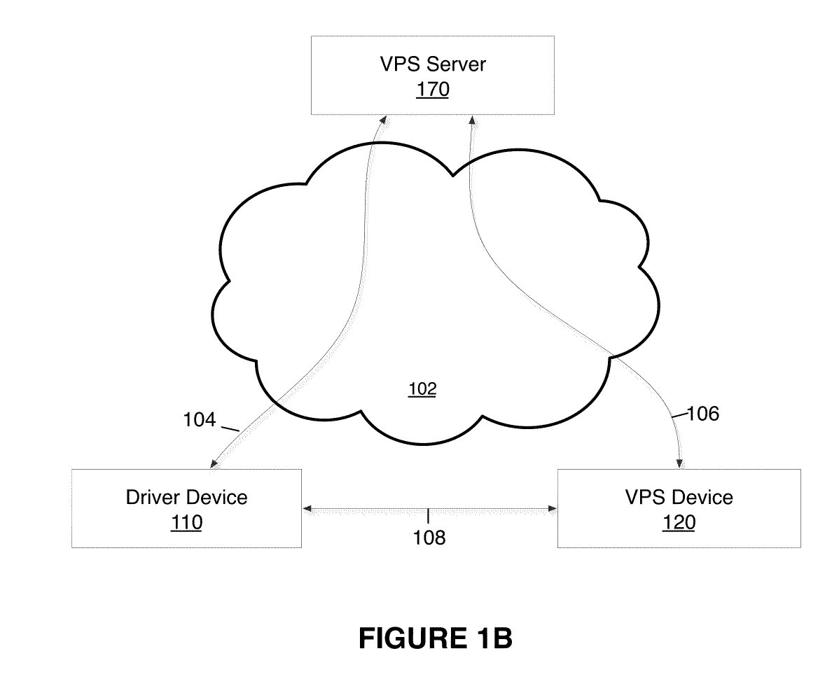

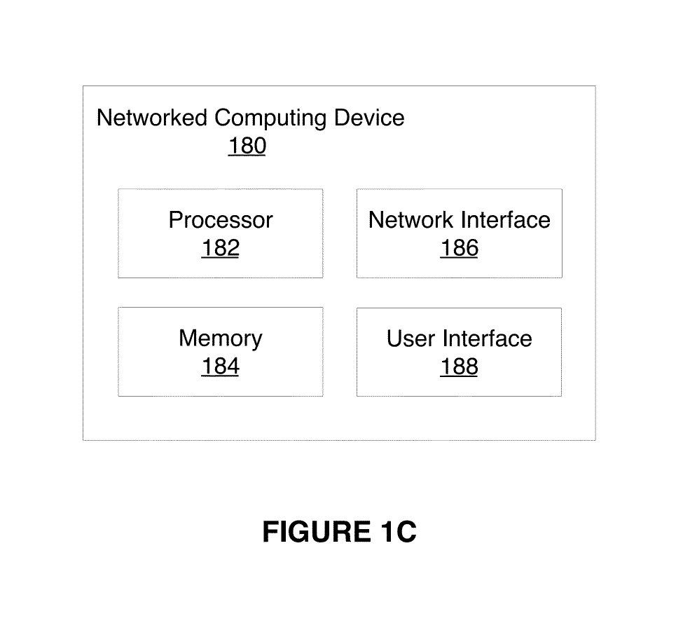

FIG. 1A illustrates an example network configuration 100 in which one or more embodiments disclosed herein may be practiced or implemented. Generally, the network configuration 100 includes computing devices, computing systems, and network infrastructure that are arranged to take the form of VPS system, and the network configuration 100 also includes other computing devices (e.g., driver devices) and systems (e.g., payment systems, etc.) that the VPS system may leverage to provide its services.

As shown in FIG. 1A, the example network configuration 100 includes a communication network 102, driver computing devices 110-114, VPS computing devices 120-124, an establishment system 130, a payment system 140, a management system 150, and a position or geo-location system 160. The network configuration 100 may include additional, different, or fewer components. For example, it may include the driver device 110 but not include the driver devices 112, 114. In some cases, the establishment system 130 may operate as a VPS device. Other examples are also possible.

Further discussions relating to the different components of the example network configuration 100 and how the components may interact to provide a driver with a parking service experience may be found in the following sections. While the discussions herein may generally refer to a VPS system, technologies described herein are not limited to VPS applications. For example, certain technologies described herein may be useful in parking environments where drivers self-park their vehicles.

Generally, the communication network 102 may be configured to facilitate communications between the various components of the network configuration 100. As such, the communication network 102 may include network infrastructure to facilitate various forms of network communication. For example, the communication network 102 may be configured according to any combination of wired and/or wireless communication technologies, such as Wi-Fi communication standards (e.g., IEEE 802.3, 802.11a, 802.11b, 802.11g, 802.11n, 802.11ac, 802.15, and/or future generations) and/or mobile telecommunication standards (e.g., 3G, 4G, LTE, and/or future generations), among other examples. Communications may include direct or indirect communications via one or more intermediary components. Communications may include transmitting and/or receiving one or more data messages. For example, in some embodiments, as discussed in more detail below, a driver device may send to a VPS system one or more messages requesting retrieval of a vehicle. The one or more messages may be exchanged via the communication network 102.

A driver device, such as the driver devices 110, 112, 114, may take the form of a networked computing device on which application software may be installed. Once a VPS app is installed (e.g., a Hiker app), the driver device may be configured to perform various VPS-related operations, such as notify a VPS system of the driver device's (and thus the driver's and vehicle's) location. In some embodiments, a driver device may be hardcoded with program instructions.

A driver device may take various forms. For example, a driver device may be a mobile computing device that a driver may carry in and out of a vehicle, such as a smart-phone (e.g., an iPhone™, Android™ phone, etc.), tablet device (e.g., iPad™, Android tablet, etc.), a wearable computing device (e.g., a smart watch, head-mountable device, etc.), or laptop computer (e.g., PC or Mac™), among other examples. Additionally or alternatively, a driver device may be embedded into a vehicle that remains in the vehicle when the driver exits the vehicle but is generally operated by a driver while in the vehicle. For instance, such a driver device might take the form of an on-vehicle computing device or system with a VPS app (e.g., a Hiker app) installed thereon. Other examples of driver devices are also possible.

In example embodiments, a given driver device may include a vehicle module and a mobile computing device. The vehicle module might be attached to, or integrated, into the vehicle. The vehicle module might include a transponder that provides or emits an identifying signal. In this instance, the vehicle can emit a signal that identifies the vehicle to listening devices. The mobile computing device may be used to perform various VPS-related functions, such as reclaiming a parked vehicle, requesting the vehicle, paying for the VPS, and/or tracking receipts, among other functions. Other examples of driver devices are also possible.

While FIG. 1 shows multiple driver devices 110, 112, and 114, it is understood that in some embodiments a single driver device may be used to facilitate the VPS technology described herein. It is also understood that a single driver might have multiple driver devices, in which case any of the driver devices may be used. It is further understood that two or more persons may be associated with a single driver profile and/or vehicle. For example, it is possible for a husband and wife to share the same vehicle, and so, a single driver profile may be assigned to them. Moreover, a given driver device may be associated with more than one vehicle. By way of illustration, David may have three vehicles in his family, each of which may be associated with David's driver device. Additionally or alternatively, one or more of those vehicles may be associated with a different driver device (e.g., David's wife's driver device). Other scenarios are also possible.

Additionally, it should be understood that a driver device may be owned, operated, controlled, and/or otherwise used by a “user.” Moreover, a user may be a “driver,” “passenger,” or “owner” of a vehicle that may be parked via a VPS. As such, these terms may be used interchangeable herein unless otherwise noted.

A VPS device, such as VPS devices 120, 122, 124, may be a networked computing device on which application software may be installed. Once a VPS app is installed (e.g., a Hiker app), the VPS device may be configured to perform various VPS-related operations, such as notify parking attendants of vehicle-retrieval requests. In example implementations, a VPS device may be located at, near, or in proximity to the entrance of an establishment or the like that is affiliated with the VPS (e.g., at a valet stand). In examples where there are multiple VPS devices, some VPS devices may be fixed at a particular location (e.g., at a valet or hostess stand), while others may be mobile (e.g., carried by parking attendants). Other examples are also possible.

A VPS device may take various forms. For example, a VPS device may be a smart-phone (e.g., an iPhone™, Android™ phone, etc.), tablet (e.g., iPad™, Android tablet, etc.), wearable computing device, or laptop computer (e.g., PC or Mac™), among other examples. It should be understood that a VPS device may be owned, operated, controlled, or otherwise used by, for example, a parking-service company (e.g., a valet company), or a restaurant, hotel, hospital, airport, arena, or other establishment, among other examples.

An establishment system, such as the establishment system 130, may take the form of one or more computing devices and/or systems that facilitate managing operations of an establishment (e.g., a restaurant). For instance, where the establishment is a restaurant or hotel, the establishment system 130 may be configured to facilitate recording, retrieving, or otherwise handling customer reservations, customer contact information, customer notes, customer special needs or requests (e.g., allergies, prefers a window table, etc.), table or room assignments, and/or payment information, among other restaurant- and/or hotel-related operations.

As one example of an establishment system, OpenTable is an Internet connected service that facilitates various restaurant-related operations, such as providing table assignments and/or allowing users to make reservations online, among other operations. Another example of an establishment system may take the form of a hotel management system that a hotel may use to manage hotel-related operations, such as, for example, reservations, customer notes or requests (e.g., dog and/or smoke allergies, North facing room, etc.), payment information, customer contact information, and so on. Other examples of establishment systems are also possible.

A payment system, such as the payment system 140, may take the form of one or more computing devices and/or systems that facilitate managing electronic payments. The payment system may include, for example, an interface to a payment gateway, a payment gateway, and/or other payment system components that verify funds and clear payments. In some embodiments, the VPS system may interface with a company that processes credit card payments by providing a merchant account, payment gateway, and credit card storage. Braintree Inc. is an example company that offers such services and accepts payments online and on a mobile software application. Other payment systems are also possible.

A management system, such as the management system 150, may take the form of one or more computing devices and/or systems that facilitate managing the overall operations of a VPS system. For example, the management system 150 may provide access to one or more components of a VPS system, such as VPS devices 120-124, the establishment system 130, and/or the payment system 140. Moreover, the management system 150 may be configured to collect data from various components of a VPS system and/or other data sources and provide access to such data or a representation of such data.

A position or geo-location system, such as the position system 160, may take the form of one or more computing devices and/or systems configured to provide location information, such as, for example, global positioning system (GPS) coordinates, proximity information, and so on. For example, the position system 160 may provide information to a driver device 110-114 so that the driver device may determine its GPS coordinates, which may be used in various operations. In another example, the position system 160 may provide VPS devices 120-124 driver devices' respective GPS coordinates, such that the VPS devices may determine which driver devices are in proximity to the VPS devices. Other example operations are also possible.

In operation, the position system 160 may facilitate determining that a particular driver device is approaching or has arrived at a particular location (e.g., the location of a given establishment, valet stand, etc.). For example, based on information from the position system 160, a VPS device may determine that a driver device is within proximity (e.g., a certain distance or communication range) of the particular location. Similarly, the position system 160 may facilitate determining that a particular VPS device is approaching or has arrived at a particular location (e.g., when a parking attendant returns a vehicle to the entrance of an establishment or when a parking attendant parks a vehicle in a parking lot). For example, based on information from the position system 160, a VPS server may determine that a VPS device is within proximity of a particular location.

In some example embodiments, driver devices and/or VPS devices may utilize information from the position system 160 to make proximity determinations. For instance, a driver device may determine its proximity to a VPS device and vice versa. Specifically, in one example, determining whether a driver (or VPS) device is within proximity to a VPS (or driver) device may include the driver (or VPS) device determining its GPS coordinates and then exchanging position messages with the VPS (or driver) device. In practice, driver and VPS devices may communicate position messages using, for example, short-range wireless communications (e.g., Apple iBeacon), near field communication (NFC), and/or Bluetooth, among other technologies. Driver and VPS devices may determine each other's relative positions in other manners as well.

As suggested above, communications between driver devices, VPS devices, and VPS servers may take various paths. To illustrate this point, FIG. 1B shows a conceptual illustration of example signal flow between components of the network configuration 100 of FIG. 1A. For the sake of example and explanation only, some of the VPS operations may be discussed below with reference to FIG. 1B, but this should not be construed as limiting.

As shown in FIG. 1B, the driver device 110 is communicatively coupled to a VPS system that includes the VPS device 120 and one or more VPS servers 170. In example embodiments, the VPS server 170 may be or include the establishment system 130 and/or the management system 150 from FIG. 1A, among other systems.

In FIG. 1B, the VPS server 170 (or group of servers) may take the form of one or more computing systems that are located geographically remote from the VPS (e.g., establishment offering a parking service), the VPS device 120, and/or the driver device 110. The actual distance conveyed by the term “remote” may vary depending on the particular embodiment, but generally, the word “remote” indicates that the VPS server 170 is a distance apart from the driver device 110 and/or the VPS device 120. For instance, the VPS server 170 could be physically located within the same city as either the driver device 110 or the VPS device 120, in the same state, in the same country, or across the world.

Regardless of its geographical location, the VPS server 170 may generally be configured to receive data from various sources and use such data to facilitate the operations of the embodiments described herein. For instance, the VPS server 170 may be configured to centrally store data and provide other networked devices (e.g., the driver device 110 and/or the VPS device 120) access to such data to perform the VPS-related operations discussed herein. Moreover, the VPS server 170 may be configured to allow access to other network accessible devices and tools to analyze the data residing at the VPS server 170.

In any event, as shown in FIG. 1B, the driver device 110, the VPS device 120, and/or the VPS server 170 may communicate over various wireless routes. For example, a first data route may include the wireless paths 104 and 106 where the driver device 110 and the VPS device 120 communicate indirectly via the VPS server 170 located remote from a local vehicle-parking operation. In another example, according to certain embodiments, a second data route may include the wireless path 108 where the driver device 110 and the VPS devices 120 may communicate directly (e.g., not through an intermediary system) over wireless path 108. Other wireless routes are also possible.

It should be understood that, in some embodiments, the VPS system described herein may utilize both the first and second data routes. For example, in operation, the driver device 110 might send a notification message that includes an identifier to the VPS device 120 via the wireless path 108. The VPS device 120 may then use the identifier to request information from the VPS server 170 (e.g., information regarding the type of vehicle that corresponds to the identifier) via the wireless path 106. In another example, the VPS device 120 may update the “state” of a given vehicle via the wireless path 106 by notifying the VPS server 170 that the vehicle is, for example, in a to-be-parked queue, parked in the parking lot, in a driver-requested queue, or delivered back to its driver. In yet another example, the driver device 110 may communicate with the VPS server 170 via the wireless path 104, such as when requesting a vehicle, sending an image of a paper parking ticket, and/or sending profile information, among other operations.

In example embodiments, as communications occur between the driver device 110, the VPS device 120, and/or the VPS server 170, a timestamp may be created and stored for the given communication. In some cases, the VPS server 170 stores such timestamps, although the timestamps could be stored elsewhere. For instance, an action may be taken at the driver device 110 or the VPS device 120 that results in a message being sent to the VPS server 170. The VPS server 170 may then log the details of the message in a database, perhaps along with a timestamp, and the VPS server 170 may then perform a number of other operations after processing the contents of the message, some of which are discussed in further detail below.

### III. Example Devices & Systems

FIG. 1C shows a functional block diagram of an example networked computing device 180 that may be configured as a driver device 110-114 and/or a VPS device 120-124 from FIG. 1A. As shown, the networked computing device 180 may include at least one processor 182, memory 184 (e.g., data storage), at least one network interface 186, and a user interface 188, some or all of which may be electrically coupled to each other. It should be understood that the networked computing device 180 may include more, fewer, or additional components in certain cases.

The processor 182 may include one or more general-purpose and/or special-purpose processors and/or microprocessors that are configured to perform various operations of a computing device. The memory 184 may include a non-transitory computer-readable medium, such as optical, magnetic, or flash memory. The memory 184 may be configured to store programs instructions that are executable by the processor 182 to perform various functions described herein. The memory 184 may also be configured to store third-party apps (e.g., the Hiker app), firmware, and/or other data. As such, the networked computing device 180 may be configured to run an operating system (e.g., iOS, Android, Windows, etc.) and third-party apps.

The at least one network interface 186 may generally facilitate communications with the communication network 102 and the other components of the network configuration 100. The network interface 186 may be configured according to one or more wired and/or wireless communication technologies, such as any discussed above. In some embodiments, the networked computing device 180 may include multiple network interfaces, each of which may be configured according to a different communication standard. For instance, the networked computing device 180 may include at least two network interfaces, one of which is configured for short-range communications (e.g., iBeacon) and another configured for longer-range communications (e.g., cellular communications). Other examples are also possible.

The user interface 188 may generally facilitate user interaction with the networked computing device 180. Specifically, the user interface 188 may be configured to detect user inputs and/or provide feedback to a user, such as audio, visual, audiovisual, and/or tactile feedback. As such, the user interface 188 may be or include one or more input interfaces, such as mechanical buttons, “soft” buttons, dials, touch-screens, etc. In example implementations, the user interface 188 may take the form of a graphical user interface configured with input and output capabilities. Other examples are also possible.

While FIG. 1C shows the networked computing device 180 as a single device, it should be understood that a given networked computing device may include or take the form of multiple devices. For example, in certain embodiments, a driver device may take the form of mobile device and device attached to or integrated with a vehicle, such as a transponder. A transponder or the like might be configured to provide vehicle identification and/or location information to a VPS system. Other examples are possible.

In example embodiments, a given computing system described herein may take the form of one or more computing systems and/or devices that are communicatively connected and configured to carry out one or more operations. In some cases, a given computing system may take the form of one or more servers and/or a network of computers and databases. As such, a computing system may include one or more network interfaces, one or more processors, and memory that includes program instructions that are executable by the one or more processors to carry out the various operations of a computing system described herein.

### IV. Example Method for Utilizing a VPS System

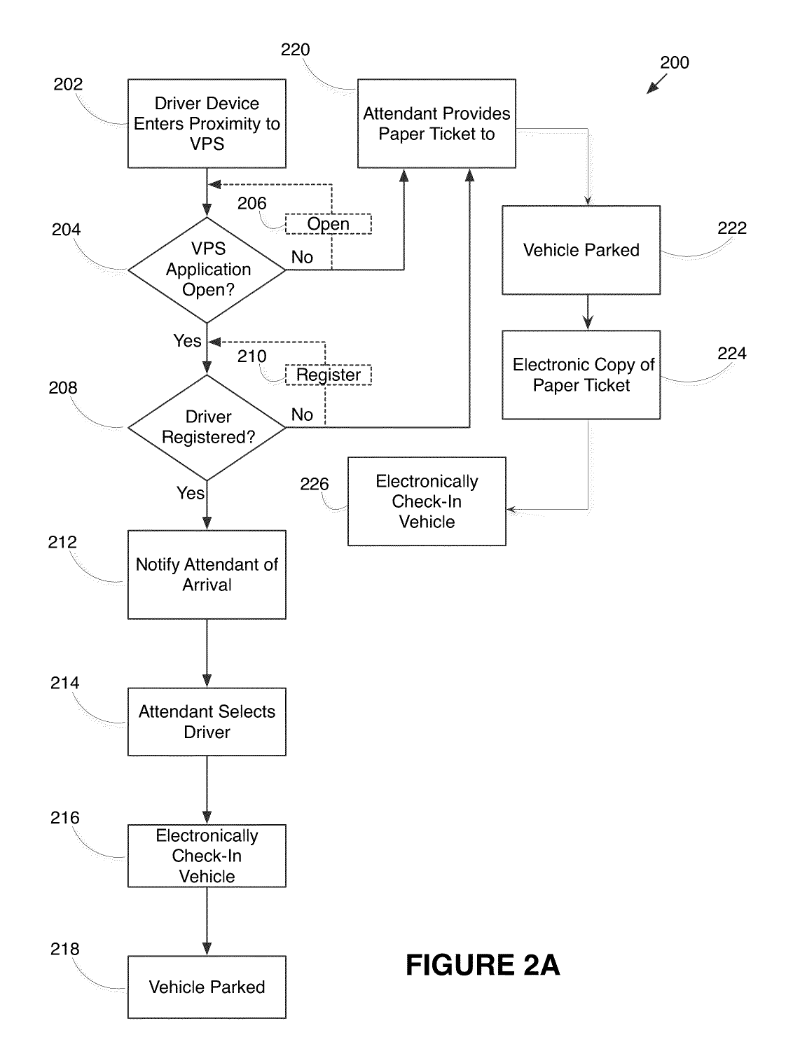

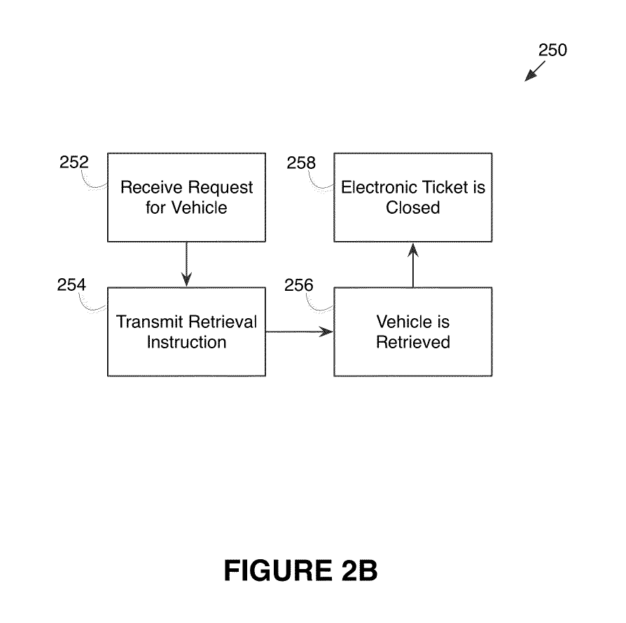

Method 200 shown in FIG. 2A illustrates an embodiment of a method that can be implemented within an operating environment involving, for example, a VPS system. The method 200 may include one or more operations, functions, or actions as illustrated by one or more of blocks 202-226. Although the blocks are illustrated in sequential order, these blocks may also be performed in parallel, and/or in a different order than those described herein. Also, the various blocks may be combined into fewer blocks, divided into additional blocks, and/or removed based upon the desired implementation.

At block 202, the method 200 may involve determining that a driver device (e.g., any of the driver devices 110-114 from FIG. 1A) has entered within proximity to a VPS. In example embodiments, a VPS server, a VPS device, or some combination thereof may make this determination.

Generally, proximity to a VPS may be defined based on (i) the location of an establishment or the like associated with the VPS, (ii) the location of a parking-attendant point of contact (e.g., a valet stand or the like), or (iii) the location of a particular VPS device, among other examples. A driver device may be considered within proximity to a VPS when within a threshold distance of the VPS or within communication range of a VPS device or system, among other examples. In some embodiments, the proximity may be based on the particular technology used by the driver and/or VPS device to discover other devices.

As one example, a driver device may be deemed within proximity to a VPS device when the driver device is within 200 feet of a VPS device, although other distances may be possible and programmed accordingly. In some embodiments, limiting the proximity to a shorter distance (e.g., even less than 200 ft.) may allow for a better understanding by a parking attendant of what vehicles are ready to be parked versus vehicles with driver devices that are merely driving by, or near, the VPS. In some cases, it might be worthwhile to limit proximity to within a short distance from the valet stand itself, such as determined by the size of the valet-loading zone. In other cases, it might be worthwhile to expand the proximity to cover a larger range (e.g., like one or more city blocks), for example, so that the VPS system can notify a driver about various parking services in the area and/or offer discounted services or the like (e.g., “We noticed you are in the area, please stop by within the next hour to receive a parking discount at Johnny's”).

As noted above, a VPS server may be configured to determine that a driver device is within proximity to a VPS. Referring back to FIG. 1B, this operation may involve the VPS server 170 receiving a location message including location information (e.g., GPS coordinates) of the driver device 110. In some cases, this message might come from the driver device 110 itself, while in other cases this message might come from another device or system, such as the VPS device 120 or the position system 160 of FIG. 1A.

Based on the location information of the driver device 110, the VPS server 170 may determine whether the driver device 110 is relatively close to (e.g., within a threshold distance from) any VPSs that the VPS server 170 facilitates operations for. In some implementations, this operation may involve the VPS server 170 determining the distance between the driver device 110 and participating VPS devices (e.g., VPS devices of VPSs that the VPS server 170 facilitates operations for). According to some embodiments, such a determination may involve VPS devices providing to the VPS server 170 respective location information of the given VPS device. In some cases, the VPS server 170 may determine that the driver device 110 is near more than one VPS.

In any event, the VPS server 170 may send to the driver device 110 one or more messages identifying any nearby VPSs. Such a message might identify the name of the VPS, the name of an establishment affiliated with the VPS (e.g., “Nellcote is nearby”) and/or the address of the VPS, among other information. Similarly, the VPS server 170 may send to nearby VPS devices (e.g., the VPS device 120) one or more messages identifying any nearby driver devices (e.g., the driver device 110). Such a message might identify a particular driver name, type of vehicle, vehicle color, license plate number, pictures and/or other information associated with a given nearby driver device. In some cases, the VPS server 170 might include in the messages additional information from the driver profile associated with the driver device 110.

As noted above, the threshold proximity (e.g., distance) between the driver device 110 and a VPS that triggers the VPS server 170 to transmit messages may be adjusted and programmed according to any number of considerations. In some instances, a hundred feet would be desirable. In other instances, it might be worthwhile to extend the distance. In some instances, the distance that triggers the VPS server 170 to send to the driver device 110 a message identifying nearby VPS devices might be different than the distance that triggers the VPS server 170 to send to the VPS device 120 a message identifying the nearby driver device 110. Other examples are also possible.

In some embodiments, the driver device 110 might receive from the VPS server 170 a message indicating that a VPS is nearby the driver device 110. The VPS name (or some other name, like a restaurant name “Nellcote”) may be displayed on the graphical user interface of the driver device 110. For instance, a message may be received at the driver device 110 that causes the driver device 110 to display one or more names or other identifiers of VPSs nearby the driver device 110. By way of illustration, the graphical user interface might display, “Nellcote is nearby,” among other examples.

More information about nearby VPSs or establishments, for instance, such as a restaurant's menu or hours, may be provided via the driver device 110 as well. For instance, a hyperlink might appear on the driver device 110 that, when selected, opens the restaurant's website. As the vehicle moves a threshold distance away from the venue or VPS, the hyperlink may be removed from the display on the driver device 110. Other examples are also possible.

Returning to the method 200, at block 204, a determination is made by, for example, the VPS server, whether a VPS application is open on the driver device. In example embodiments, the VPS server may determine that the VPS app is open on the driver device based on receiving an explicit notice from the driver device that the app is open or based on inferring that the app is open via receiving VPS-related data from the driver device. In practice, a VPS app may be considered “open” even when the app is running in the background on the driver device. Background operation may allow the app to run behind the scenes and without user intervention.

If a determination is made at block 204 that the app is not open on the driver device (“No”), the VPS server might provide a notification to a VPS device for the parking attendant to provide a paper ticket to the driver at block 220 (e.g., when the driver arrives at the VPS). As described below, in some embodiments, that paper ticket may be converted to an electronic ticket, which can be used to request a vehicle and/or electronically pay for the service. Notably, as shown by block 206, a driver may open the VPS app sometime (1) after a first determination is made at block 204 that the app is not open and (2) before the driver arrives at the VPS and receives a paper ticket.

Returning to block 204, in the event a determination is made that the VPS application is open on the driver device (“Yes”), then a determination is made whether the VPS app on the driver device has a registered driver at block 208. The determination whether the VPS app on the driver device has a registered driver may be based on, for example, a state variable maintained by the VPS app indicating there is a registered driver. The driver device may transmit the state variable to the VPS system, for example, when the driver is first registered, when the VPS app is subsequently opened, or at some other time.

If a determination is made that the VPS app on the driver device does not have a registered driver (“No”), the driver may register using the VPS app on the driver device at block 210. Registering a driver may include, for example, providing information, such as driver information (e.g., name, address, etc.), vehicle information (e.g., make, model, color, license plate, etc.), and/or payment information (e.g., credit card, etc.). In the event a driver decides not to register, then the parking attendant may provide the driver with a paper ticket at block 220, at which point the attendant might use the VPS device to note that the paper ticket was issued to the given driver.

In the event that the driver is registered, at block 212, a determination is made by the VPS server, the VPS device, or some combination thereof that the driver device is within proximity of the VPS. This operation may be performed, for example, based on location information provided by the driver device, the VPS device, and/or the location system 160, among other examples. Once it is determined that the driver device is indeed within proximity of the VPS, the VPS server may transmit to the VPS device a notification of the driver's arrival or imminent arrival. Alternatively, in some embodiments, the driver device may provide a notification to the VPS device.

Either way, the parking attendant receives some form of a notification at his or her VPS device. Then, at block 214, the parking attendant may use the VPS device to select the driver's vehicle for automatic check-in. For example, the graphical interface of the VPS device might display “Red BMW 328i,” which the attendant may select when the driver drops off that same vehicle at, for example, the valet stand. The graphical interface might also display the driver's name, and so, the attendant may confirm that the actual driver and vehicle match the information provided by the VPS system (e.g., “Welcome Mr. Lang”). As such, the VPS system may be used to help enhance the driver's experience with the VPS and the overall experience of the occasion.

Returning to the method 200, at block 216, the driver's vehicle is automatically checked in via the VPS system. In some embodiments, automatic check-in does not include human interaction. For instance, based on the driver device's location relative to the VPS, the VPS system might automatically check-in the driver's vehicle. In other embodiments, automatic check-in may only involve human interaction by the attendant and not the driver. For example, automatic check-in may result from the VPS device receiving an input from the attendant confirming the presence of the vehicle. Notably, this check-in does not include any interaction from the driver (e.g., retrieving his or her driver device, unlocking the device, opening an application to scan a QR code, etc.). In yet other embodiments, after the driver's vehicle is checked in, the driver may receive at his or her driver device a message requesting that the driver confirm the check-in. Notably, this confirmation may be performed at some later time (e.g., when the driver is seated at his or her table).

It should be understood that actual “check-in” might occur when the parking attendant determines that an arriving driver in his or her vehicle is intending to use the VPS, and the attendant selects “check-in” on the VPS device 120. Then, a message is sent to the VPS server 170 that the vehicle is checked into the VPS. An example might be that the vehicle pulls up near a valet stand, and the driver exits the vehicle to go inside the restaurant. At that time, or some time thereafter, the parking attendant can select a “check-in” icon or the like for that vehicle via the VPS device 120.

In another example, the parking attendant might also confirm verbally or through body language with the driver that the vehicle is to be parked. At some point thereafter, the parking attendant can select the option to check the vehicle into the VPS system. In yet another example, if it was known by the VPS server that the driver was going to use the VPS beforehand (e.g., the driver indicated parking would be used when making a dinner reservation via OpenTable), then check-in may be programmed to be automatic and upon arrival (or a time at, or near, the arrival time) of the driver device 110 (and thus vehicle). For instance, such automatic check-in might be based on location information of the driver device 110.

It should also be understood that a given driver might have more than one vehicle associated with the driver device 110. If so, then an indication of each vehicle associated with the driver device 110 might be provided to and displayed via the VPS device 120. The parking attendant can view the choices and select the appropriate vehicle for check-in. For example, the parking attendant might see that a blue BMW 328i is parked curbside and a representation of a blue BMW 328i shows up on VPS device 120 as one of the vehicle choices. The parking attendant can then select that option via the VPS device 120, which then sends notice of the particular vehicle to the VPS server 170.

In example embodiments, automatic check-in may also involve the VPS system generating an electronic ticket (sometimes referred to herein as an “e-ticket”), although electronic tickets may be generated independent from a check-in. Specifically, the VPS server might generate an electronic ticket based on location information of the driver device, while in some cases, the parking attendant might input certain information at the VPS device that is relayed to the VPS server that then generates an electronic ticket based on the input provided at the VPS device. Other examples are also possible.

An electronic ticket may include a unique identifier (e.g., a numeric, alphabetic, or alphanumeric identifier) or some other indicator that may be used to associate a particular vehicle to its corresponding driver. The electronic ticket may be provided to the driver device and/or the VPS device. For instance, the VPS server might transmit an e-ticket to the driver device and/or the VPS device via the communication network 102.

As an illustrative example, referring back to FIG. 1B, around the time that the parking attendant visually spots a vehicle, information about that vehicle might also be displayed to the attendant via the VPS device 120 (e.g., David's Yellow BMW 328i). The parking attendant might then check in David's BMW 328i by selecting an icon or the like corresponding to that vehicle via the VPS device 120. The VPS device 120 may then send to the VPS server 170 a message indicating that BMW 328i is checked-in (or about to be checked-in). The VPS server 170 may then generate an electronic ticket that includes an identifier where the electronic ticket (and thus, the identifier) is assigned to the driver (e.g., “David”), the driver's vehicle (e.g., BMW 328i) and/or the driver device 110. The VPS server 170 may send the electronic ticket or a portion thereof (e.g., just the identifier) to the driver device 110 and/or the VPS device 120, each of which may store the e-ticket or portion thereof in memory. As such, the driver device 110, the VPS device 120, and the VPS server 170 all have a matching electronic ticket or portion thereof that is assigned to the vehicle.

The driver device 110 might then be able to display the electronic ticket and/or identifier on the graphical user interface of the driver device 110, which may be later used to pick-up the vehicle. For instance, the driver might show the electronic ticket and/or identifier to the parking attendant, who might then visually match the identifier on the driver device 110 to the identifier corresponding to the vehicle on the VPS device 120 of the parking attendant. Other examples are also possible.

In some cases, the VPS server 170 might also send the driver device 110 a message, which may be separate from the above e-ticket message, indicating that the driver's vehicle has been checked-in and/or parked by a parking attendant. Such a message might provide the driver confirmation that his or her vehicle is indeed being serviced by the VPS.

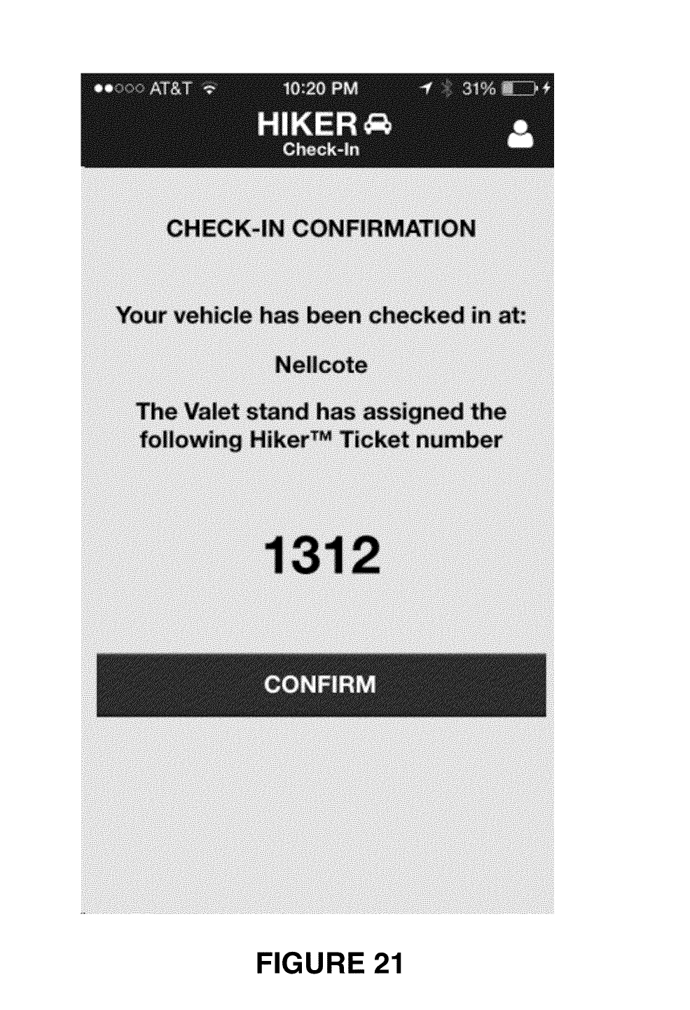

FIG. 21 shows an example screenshot of a graphical user interface shown on a driver device after its associated vehicle is checked in. As shown, “Nellcote” is the name of the establishment affiliated with the VPS, and the vehicle (and thus driver device) has been assigned identifier “1312.” In an embodiment of FIG. 21, the driver can select the “Confirm” icon via the driver device 110 to confirm that his or her vehicle is to be checked-in to the VPS. Notably, driver side confirmation may not always be required, but it can provide an additional check. In any event, the driver device 110 may transmit a confirmation message to the VPS server 170 if the “Confirm” icon is selected.

Returning to the method 200, at block 218, the VPS system determines that the vehicle has been parked. This operation may occur in a variety of manners. For example, the VPS server might receive an indication from the VPS device that the attendant parked the vehicle. Specifically, the VPS system may request that the attendant provide at the user interface of the VPS device an input indicating that the vehicle is now parked. Thereafter, the VPS device may transmit to the VPS server a message indicating the same. In another example, the VPS system may determine that the vehicle has been parked based on location information of the VPS device (e.g., carried by the attendant that is now driving the vehicle) and the location of the VPS parking lot. Other examples are also possible.

In some embodiments, after the VPS system determines that the vehicle has been parked, the VPS system may provide to the driver device a message confirming that the vehicle has been parked. Moreover, the VPS system may record the location where the vehicle is parked (e.g., parking lot information or GPS coordinates), which may also be provided to the user.

Returning to block 220, in the event that the parking attendant provides a paper ticket to the driver (which might happen regardless of whether one has the app or not, due to any number of reasons), the driver may enter the establishment while the attendant proceeds to park the vehicle. At block 222, the VPS system may determine that the vehicle has been parked in a manner similar to block 218.

Thereafter, at block 224, the VPS system may receive a paper-ticket conversion message from the driver device. The paper-ticket conversion message may include an electronic copy of the paper ticket that was provided by the attendant at block 220. For instance, if needed, a driver may download the VPS application to the driver device and register. Once the VPS application is open, the driver can convert the paper ticket to an electronic ticket. In some embodiments, this may be done by capturing an image of the paper ticket via a camera of the driver device. The image may then be provided to the VPS system, which then takes record of the conversion. In other embodiments, the paper-ticket conversion might involve the driver manually entering information from the paper ticket into the VPS application via the driver device. Other examples are also possible.

In some implementations, after the VPS system receives notice of the paper-ticket conversion, at block 226, the VPS system may electronically check-in the vehicle based on the electronic submission of the paper ticket. This operation may involve the VPS system generating a unique identifier to associate the vehicle, driver, and/or driver device to the electronic copy of the paper ticket. In this instance, generating the unique identifier may or may not be in conjunction with the VPS system generating an electronic ticket. That is, in some case, the electronic copy of the paper ticket (e.g., image of the paper ticket stored on the driver device) might serve as the driver's parking ticket, while in other cases, an electronic ticket is issued that replaces the use of the paper ticket and any electronic copy thereof. Other examples are also possible.

Turning now to FIG. 2B, there a method 250 is illustrated for retrieving a vehicle parked with a VPS. The method 250 may include one or more operations, functions, or actions as illustrated by one or more of blocks 252-258. Although the blocks are illustrated in sequential order, these blocks may also be performed in parallel, and/or in a different order than those described herein. Also, the various blocks may be combined into fewer blocks, divided into additional blocks, and/or removed based upon the desired implementation.

At block 252, the VPS system may receive from a driver device a request for the driver's vehicle. For instance, when the driver is ready to retrieve his or her vehicle, the driver may access the VPS application via the driver device. Using the driver device, the driver may input a request for the VPS attendant to retrieve the driver's vehicle. The driver device may transmit a request message to the VPS server.

At block 254, the VPS system may then transmit a retrieval instruction to the VPS device. The retrieval instruction might include various information, such as the name of the driver, the urgency of the request, and/or vehicle information (e.g., make, model, color, license plate information, location and/or spot number where the vehicle is parked), among other information.

At block 256, the VPS system may receive confirmation that the vehicle has been retrieved and/or delivered to the driver. In some examples, the confirmation may come from the VPS device and/or the driver device. For example, after the attendant retrieves and delivers the vehicle to the driver, the attendant may provide an input at the VPS device indicating that the vehicle has been retrieved. In another example, after the driver receives his or her vehicle, the driver may provide an input at the driver device indicating that he or she has received the vehicle (e.g., an input that closes the VPS application or an input that explicitly notifies the VPS application that the vehicle has been retrieved). Other examples are also possible.

At block 258, the VPS system may close the electronic ticket that was assigned to that particular vehicle/driver. For example, the VPS system may void that electronic ticket and/or update the driver's profile to indicate that that electronic ticket is no longer assigned to the driver and his or her vehicle. Other examples are also possible.

### V. Example VPS Queues

In operation, the VPS system includes one or more queues that are used to facilitate some of the VPS operations described herein. In an example embodiment, referring to FIG. 1B, the VPS device 120 receives from the VPS server 170 a message that the driver device 110 is nearby. The VPS device 120 may then display driver information for the driver associated with the driver device 110. The parking attendant operating the VPS device 120 may select an icon corresponding to the driver for check-in. The VPS device 120 may then send one or more messages to the VPS server 170 indicating that the vehicle is checked-in. The VPS device 120 may in turn receive an e-ticket or portion thereof (e.g., identifier) corresponding to the driver device 110. The VPS server 170 might also add the identifier associated with the driver device 110 (and thus, the vehicle) or some other indication associated with or otherwise representing the vehicle in a particular queue stored or otherwise maintained by the VPS server 170 and/or the VPS device 110.

In example implementations, a queue includes a representation of vehicles corresponding to driver devices whose drivers are utilizing or have utilized the VPS. A queue may take various forms, such a list of identifiers and/or vehicle descriptions corresponding to particular driver devices. The order of vehicles in a particular queue may be prioritized by time, among other considerations. In practice, the VPS system may include a variety of queues, such as a vehicle “to-be-parked,” “in-lot,” “requested,” and “completed” queue, among other queues.

In example embodiments, the VPS server 170 maintains a master copy of each queue used by the VPS system. The VPS device 120 can request a portion, or all, of the information in such queues, which the VPS server 170 may provide. Additionally, such queues may be accessible by other computing devices that have been given access and used in operational management of the VPS. In some embodiments where the VPS server 170 is not utilized, the VPS device 120 may maintain the master copy of each queue.

In operation, a vehicle associated with the driver device 110 is first placed in a “to-be-parked” queue by the VPS server 170 when the VPS server 170 (or VPS device 120) determines that the driver device 110 is nearby the VPS. Such a queue may be prioritized based on a variety of considerations.

By way of illustration, assume that all vehicles having an associated driver device that are within 75 feet of the VPS device 120 will use the services of the VPS of the VPS device 120. Further assume that five different vehicles are currently within 75 feet of the VPS device 120. All five vehicles may be added to a to-be-parked queue, which may be prioritized according to, for example, a time that each vehicle entered the 75 foot radius, amount of time spent in the 75 foot radius, vehicle characteristics (color, type, make, model, cost, etc.), and/or some other considerations. When a vehicle moves outside of the 75-foot radius, the vehicle may be removed from the queue (e.g., the VPS server 170 may remove the queue entry corresponding to the vehicle from the queue and accordingly provide this update to the VPS device 120).

After check-in, a vehicle may then placed by the VPS server 170 in an “in-lot” queue based on messaging from the VPS device 120. In some cases, the VPS server 170 may place a vehicle in an “in-lot” queue, but the vehicle itself may still be parked at the valet stand (e.g., waiting to be parked), in transit to the lot, or in the lot itself. Moreover, a parking attendant can also enter parking information into the VPS device 120 regarding where the vehicle is parked, such as the vehicle lot or parking spot number. In some embodiments, the VPS server 170 may provide the driver device 110 a message indicating that the driver's vehicle is parked and/or parking information. Other information regarding other service options, such as car wash, fuel fill-up, or other service options may also be provided to the driver device 110.

When a driver requests his or her vehicle using the driver device 110, the VPS server 170 may place the corresponding vehicle in a “requested” queue. The “requested” queue may be prioritized based on the time that the vehicle was requested, among other prioritization considerations. An estimated time or number of vehicles ahead of the vehicle may be provided to driver device 110 based on information in the “requested” queue. For instance, if there were five vehicles ahead of David's vehicle in the queue, and it has taken about two minutes to get each vehicle, then David could expect to wait twelve minutes for his vehicle. The VPS server 170 may compute twelve minutes and send that time to David's driver device 110. The time displayed at David's driver device 110 may be updated as vehicles are removed from the “requested” queue. Other examples are also possible.

In some example embodiments, a “retrieved” queue may include vehicles that have been retrieved by a parking attendant (as notified by the VPS device 120), and for which the VPS server 170 is waiting for confirmation that the vehicle has been delivered to the driver, if the VPS system is so programmed. The VPS server 170 places a vehicle in a “completed” queue that includes a history of vehicles that have used the VPS system. Other queues are also possible.

In example implementations, a particular VPS may have different accounts that are serviced by the VPS server 170. For instance, the particular VPS may have different parking services that are located in different geographical locations. The VPS server 170 may nonetheless facilitate VPS operations for each such location. In such cases, the VPS server 170 may be configured to maintain separate, different accounts for the particular VPS. Accordingly, each account may be associated with a separate sets of queues. With the right credentials to access the appropriate data in the VPS server 170, a VPS owner or manager may oversee his or her entire operation from a single computing device, if so desired.

### VI. Example Illustration of VPS Operations

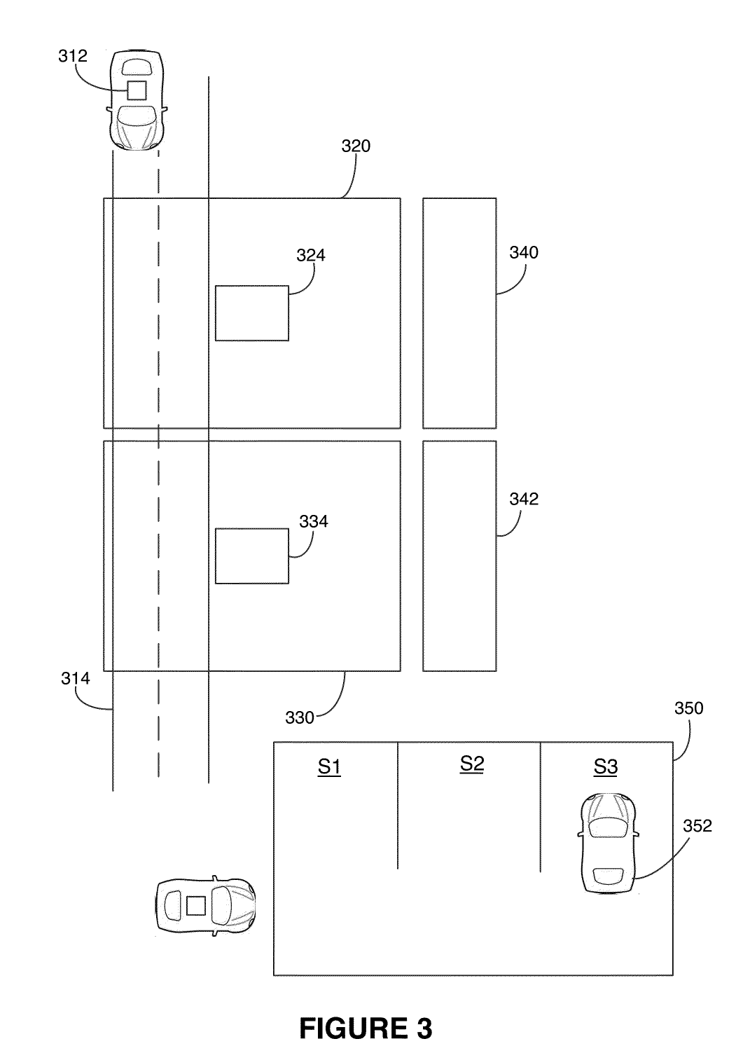

FIG. 3 shows a conceptual illustration of certain aspects of the operation of a VPS. FIG. 3 is meant to provide an exemplary illustration of a VPS. However, due to the nature of parking services and the large number of possible embodiments, such as described herein, real-world implementations may be different than that illustrated. Additionally, instead of a single vehicle arriving at an establishment, as illustrated in FIG. 3 and described below, more than one vehicle may arrive at approximately the same time.

As shown in FIG. 3, a vehicle with a driver device 312 may be proceeding along a road 314 to an establishment 342. The driver device 312 may include one or more VPS apps that provide access to VPS systems, such as described herein.

The driver device 312 may transmit notification messages to VPS systems to help identify a VPS within proximity to the driver device. For example, as shown in FIG. 3, the driver device 312 is in range of VPS 324 and 334. When a VPS app is activated at the driver device 312, the driver device 312 may notify VPS systems of the VPS 324 and 334 that the driver device 312 is within range of those VPSs 324 and 334.

In some embodiments, one or more notification messages may be sent directly between the driver device 312 and each of the VPSs 324 and 334 (e.g., a VPS device of the VPS 324 and a VPS device of the VPS 334). Alternatively, the one or more notification messages may be sent indirectly between the driver device and a given VPS, such as from the driver device 312 to a VPS cloud server of the VPS 324 and back to a VPS device of the VPS 324 and vice versa.

By way of illustration, the final destination of the driver of the vehicle is the establishment 342, not establishment 340. The VPS 324 is associated with establishment 340 (e.g., being used to operate the valet operations for establishment 340). The VPS 334 is associated with establishment 342.

In the example of FIG. 3, the VPS 324 (e.g., a VPS device of the VPS 324) has a proximity or range 320. The VPS 334 (e.g., a VPS device of the VPS 334) has a proximity or range 330. In this example, the ranges 320, 330 do not overlap. However, it is understood that in some embodiments, ranges from different VPSs may overlap such that a driver device may be in multiple ranges at the same time. Additionally, a range may not be uniform, for example, it might extend further in one direction than another direction.

In any event, the vehicle is driven with driver device 312 through the range 320 of the VPS 324 because the establishment 340 is not the final destination. Even though this is not the final destination and the vehicle will not be valeted with the VPS 324, the driver device 312 may nonetheless communicate with a VPS device and/or server of the VPS 324.

In some embodiments, the VPS device and/or server of the VPS 324 may filter out this communication based on, for example, the vehicle's time spent in range 320 (e.g., filter out vehicles that do not stay within range for 20 seconds or some other threshold amount of time), vehicle velocity in range 320 (e.g., filter out vehicles whose speed exceeds a threshold speed), or whether the driver associated with the driver device 312 has a reservation at the establishment 340, among other considerations. According to one example, in the event that the driver has a reservation at a different establishment (e.g., such as establishment 342), the VPS device and/or server of the VPS 324 may determine that the user is not planning to use the VPS 324. Filtering a communication may involve blocking (not receiving) communication signals, disregarding the communication, hiding information related to the driver, or otherwise removing the driver from a queue of vehicles to be parked, among other examples.

When the driver drives the vehicle with device 312 into the range 330, the driver device 312 may communicate with a VPS device and/or server of the VPS 334. For example, if a Hiker app is activated or running in the foreground or background, then the driver device 312 may communicate with the VPS 334. In example embodiments this communication may be to a VPS device located at the VPS 334 via a short-range communication protocol, such as iBeacon, or some other communication protocol. Alternatively, this communication may be to a VPS server affiliated with the VPS 334 via a cellular network, among other examples.

In any event, the driver device 312 may notify the VPS 334 that the driver device 312 is within range of the VPS. Irrespective of the use of filtering or not, in this example, the driver of the driver device 312 is then added to the VPS 334's to-be-parked queue that includes a list of vehicles that need to be parked by the parking attendants of the VPS 334 (e.g., “Black BMW 328i Nathan Lang” is placed in a queue of to-be-parked vehicles). The to-be-parked queue may be stored by a VPS device and/or server of the VPS 334, among other examples.

The driver may then stop the vehicle with the driver device 312 in a parking zone or other area reserved for parking operations, which may be in front of the establishment 342 and/or near a parking stand of the VPS 334. When the vehicle pulls up, a parking attendant may confirm the vehicle using a VPS device by selecting an icon or the like corresponding to the vehicle via a graphical user interface of the VPS device. For instance, the attendant might see that the vehicle is a black BMW 328i and select a representation of that vehicle within a queue displayed on the graphical interface.

Receipt of this input by the VPS device may cause the vehicle to be checked-in to the VPS system. Specifically, the VPS device may communicate to a VPS server that the vehicle is checked-in. The identifier associated with the vehicle may then be moved from the to-be-parked queue to an in-lot queue that is also stored by the VPS server

In some embodiments, the driver does not need to show the driver device or receive a paper ticket in order to be checked-in. For further identification, if so desirable, when the driver exits the vehicle, the parking attendant may greet the driver based on information provided to the attendant via the VPS device as a recognition that the vehicle was checked-in (e.g., “Welcome Mr. Lang”). Other examples of further identification are possible and can be used as desired.

In example embodiments, when the vehicle is checked-in, the VPS system (e.g., the VPS system of the VPS 334) may send a message to, for example, an establishment computer of the establishment 342 notifying the establishment (e.g., the hostess) that the driver has arrived. Moreover, in some examples, the establishment 342 may then send a response to the driver device 312 that includes information for the driver. For example, a hotel system may send a room number and electronic key information, such that the driver no longer is required to check-in at the front desk of the hotel. In another example, a restaurant computer may send a check-in confirmation and/or an estimated time until seated, such that the driver does not need to approach the host stand at the restaurant. Other examples are possible.

Once the driver exits the vehicle, the parking attendant may park the vehicle in a designated parking lot or zone. For example, the parking attendant may drive the vehicle to a parking lot 350, where there may be zero, one, or more vehicles already parked (e.g., vehicle 352 is already parked at parking spot S3). Parking information (e.g., a parking lot identifier and/or location and/or a parking spot identifier) may be provided to the VPS system via the VPS device operated by the parking attendant, if so desired. As such, the vehicle, a person associated with the vehicle (e.g., the driver or someone who is associated with driver device 312), and parking information may be logged in a database of the VPS system.

When the driver is ready for the vehicle, he or she may request the vehicle via the driver device 312. For example, the driver may use the VPS app on the driver device to electronically request the vehicle. The electronic request may be sent to the VPS server of the VPS 334 and then to the VPS device, such that a parking attendant may receive the request and retrieve the vehicle. For example, the parking attendant may retrieve the vehicle from the parking lot 350 and bring the vehicle near the establishment 342. Other examples are also possible.

### VII. Example Check-In Operations

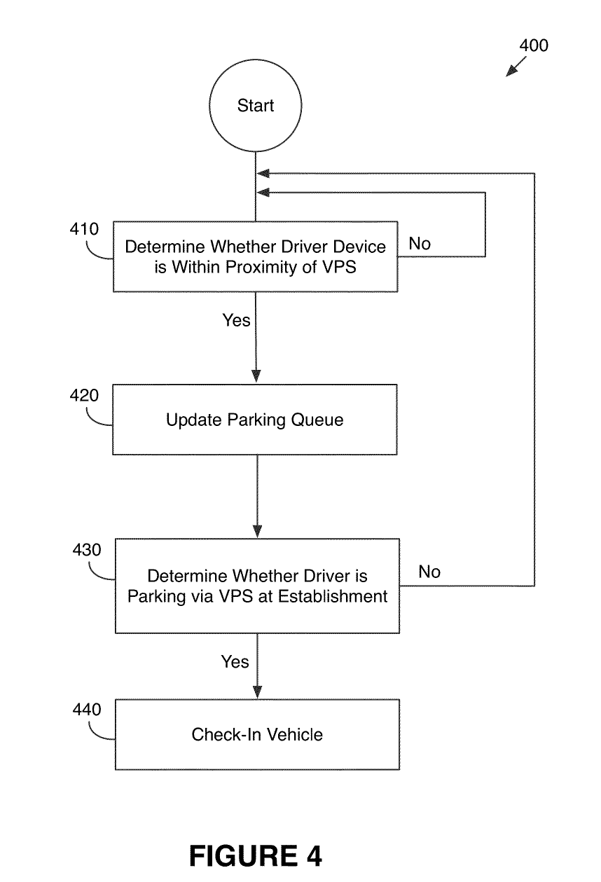

Method 400 shown in FIG. 4 illustrates an example embodiment of a method that can be implemented within an operating environment involving, for example, a VPS system. Method 400 may include one or more operations, functions, or actions as illustrated by one or more of blocks 410-440. Although the blocks are illustrated in sequential order, these blocks may also be performed in parallel, and/or in a different order than those described herein. Also, the various blocks may be combined into fewer blocks, divided into additional blocks, and/or removed based upon the desired implementation.

At block 410, a VPS device determines whether a driver device is within proximity to the VPS associated with the VPS device. In general, a driver device is within proximity to the VPS in line with the above discussion with respect to FIG. 2A. As such, in example embodiments, the VPS device may determine that the driver device is within proximity of the VPS based on location information of the driver device and of itself, of a VPS point-of-contact, or of an establishment affiliated with the VPS. Such information may be from the driver device, the location system 106, a VPS server, or some combination thereof. In other embodiments, the VPS device may determine that the driver device is within proximity of the VPS based on receiving a message from the VPS server indicating that the driver device is indeed within proximity of the VPS. Other examples are also possible.

In the event a determination is made that a driver device is within proximity to the VPS (“Yes”), then, at block 420, the VPS device may update a parking queue with information identifying the driver and/or vehicle associated with the driver device. In some cases, the VPS device may update a parking queue further based on one or more inputs provided at the VPS device by, for example, a parking attendant. As such, the VPS device may update a parking queue automatically (e.g., based on determining the driver device is within proximity to the VPS) and/or manually (e.g., based on a manual entry), among other examples. Updating the parking queue may include adding an item to the queue with information about the driver, such as his or her name, a photo of the driver, vehicle type (e.g., make, model, color, year), license plate information, or other personal and/or vehicle information, among other information.

In example embodiments, the VPS device updating a parking queue may involve the VPS device receiving from the VPS server data representing an updated queue and displaying via a graphical user interface the updated queue. That is, in some cases, the VPS server may update a parking queue and provide the update to the VPS device.

The VPS device may allow a parking attendant to filter a parking queue via the graphical user interface of the VPS device. Filtering may be performed prior to, during, or after adding an item to the queue with information about the driver. In some embodiments, the queue may be filtered without determining that a driver device is within proximity to a VPS. For example, a queue may be filtered automatically (e.g., on a timer) or manually. Filtering may be used to display a queue in the most relevant way to a parking attendant. This may involve moving information up or down in the queue and/or removing or hiding information completely.

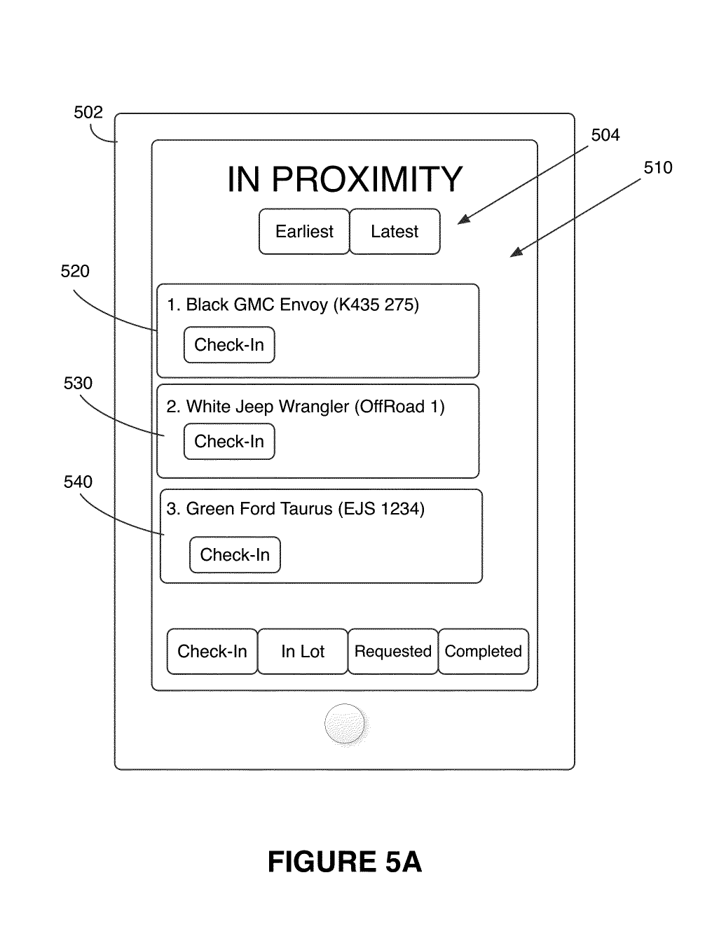

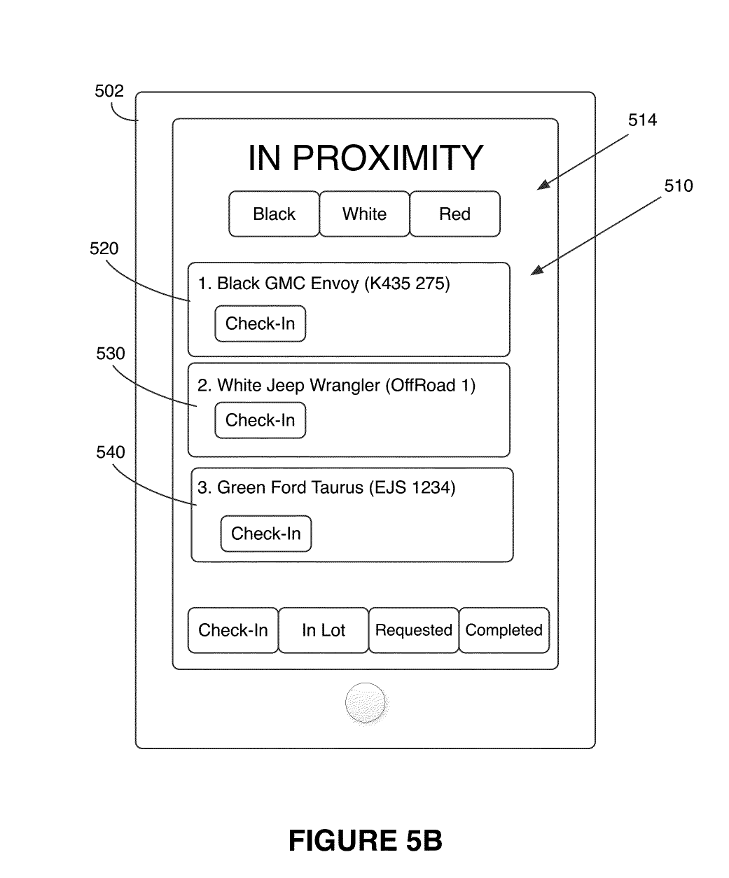

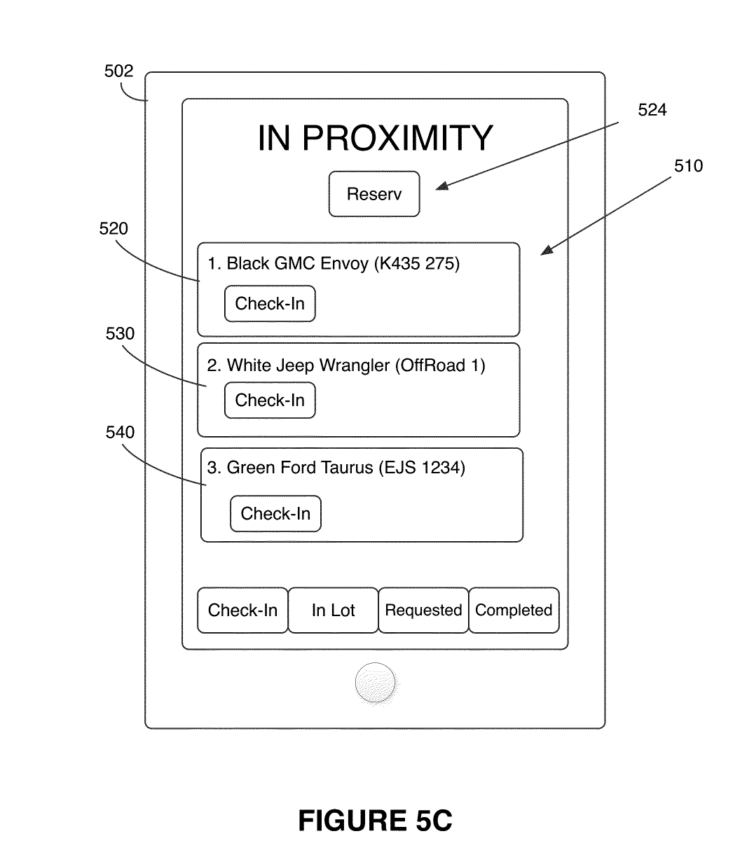

FIGS. 5A-5C show example displays that illustrate how a queue may be displayed and filtered on a VPS device 502. The examples shown in FIGS. 5A-5C illustrate queue filtering using some example criteria. It should be understood that additional criteria and/or a combination of criteria could be used to filter a queue. Furthermore, the queue may be filtered to remove or hide items in the queue.

In FIG. 5A, a “to-be-parked” queue 510 currently includes three entries. A first entry 520 is for a black GMC Envoy with a license plate “K435 275.” A second entry 530 is for a white Jeep Wrangler with a license plate “OffRoad 1.” A third entry 540 is for a green Ford Taurus with a license plate “EJS 1234.” It is understood that color of vehicle, license plate information, a user photo, or other kinds of identification are not necessary, but may be desirable in some cases.

In the example embodiment of FIG. 5A, the to-be-parked queue 510, which shows vehicles in proximity to a VPS, is filtered according to time entered (e.g., the time that the driver device associated with the particular vehicle notified the VPS that the vehicle is approaching). For instance, the Envoy was entered first, the Jeep second, and the Taurus last. In other embodiments, the valet user list 510 can be filtered to show the latest received entry on top. For instance, using filtering buttons 504, the parking attendant may select the “Latest” button to show the last entry on top. In the event that the parking attendant wants to switch back to the earliest received entry, the parking attendant can select the “Earliest” button.

It is understood that not every vehicle that shows up in the queue 510 is necessarily a vehicle to be parked. Such as described above, it may be possible that a vehicle is passing through and was picked up by the VPS system. In some embodiments, a passing vehicle might show up in the queue and then quickly disappear from the queue indicating that the vehicle was passing through. Additionally, there are filtering mechanisms that may be invoked, such as an amount of time a vehicle is in proximity, to narrow the vehicles to a list of to-be-parked vehicles.

Additionally, in some embodiments, entries of a queue may be filtered based vehicle characteristics, such as a vehicle type (e.g., all of the BMWs in one entry for further selection), vehicle color (e.g., all of the black vehicles in one entry for further selection), or some other characteristic that might be common to a group of vehicles. This may be useful, for instance, when a large number of vehicles are in proximity as it may help the parking attendant to quickly identify information about a vehicle he or she is about to park.

By way of illustration, in FIG. 5B, the queue 510 includes the same three entries as in FIG. 5A. However, in the example embodiment of FIG. 5B, the queue 510 can be filtered based on vehicle color. For example, using filtering buttons 514, the parking attendant may select the desired color. For instance, if a black Envoy pulls up to a valet stand, the parking attendant might select the “Black” filtering button to show all the black vehicles in proximity. The “White” filtering button would show all the white vehicles in proximity. The “Red” filtering button would show all the red vehicles in proximity.

In FIG. 5C, the queue 510 includes the same three entries as in FIG. 5A. However, in the example embodiment of FIG. 5C, the queue 510 can be filtered based on establishment reservations. Using filtering button 524, the parking attendant may filter by vehicles in proximity that have reservations at the particular establishment. The queue may also be filtered based on the actual time and the time of the reservations. For instance, if a green Taurus pulls up to the valet stand and the driver has a reservation at 7:00 and the actual time is 6:55, then the queue entry 540 may be moved to the top of the queue 510. Other examples are also possible.

Returning to FIG. 4, the method 400 may involve, at block 430, a VPS device determining whether the driver is using the VPS to park a vehicle at the establishment. In one embodiment, this determination may involve the VPS device receiving an input that selects an indication of the driver from a queue displayed by the VPS device. For example, a parking attendant may see a vehicle pulling up that matches a vehicle description from the queue displayed on the VPS device. The parking attendant may select the driver from the queue via the graphical interface, which may cause the VPS system to check-in the vehicle.

In another embodiment, the VPS device determining whether the driver is using the VPS to park a vehicle at the establishment may involve receiving from the driver device a message indicating, for example, that the driver would like to check-in and valet their vehicle. This embodiment may be useful in circumstances where the driver wishes to leave the vehicle for an attendant to come get the vehicle. The driver can send a message via the driver device to a VPS device letting the attendant know that the vehicle should be checked-in.

In the event a determination is made that the driver is parking the vehicle at the establishment by using the VPS affiliated with the establishment, the VPS device may then, at block 440 of the method 400, check-in the vehicle, which may be performed as discussed above.

Based on check-in of the vehicle, the VPS system may generate an electronic ticket (“e-ticket”) that includes a unique identifier (e.g., ticket number). The e-ticket may also include (or have a link to) information about the establishment, the parking attendant, the parking service fee, rules and regulations, and/or information about the driver and/or vehicle. In addition to generating the e-ticket, the VPS system may send the e-ticket to the driver device. In one embodiment, the driver device may, in turn, request confirmation from the driver to complete the vehicle check-in. As part of the check-in process, the VPS system may also send one or more messages to the establishment system 130, the payment system 140, and/or management system 150.

Once the vehicle is checked-in, the VPS system may move the information identifying the driver and/or vehicle associated with the driver device from the to-be-parked queue to a different queue that includes identifiers of vehicles that are currently check-in and parked with the VPS, such as an in-lot queue. Such a queue may be presented to the parking attendant via the VPS device in a variety of manners.

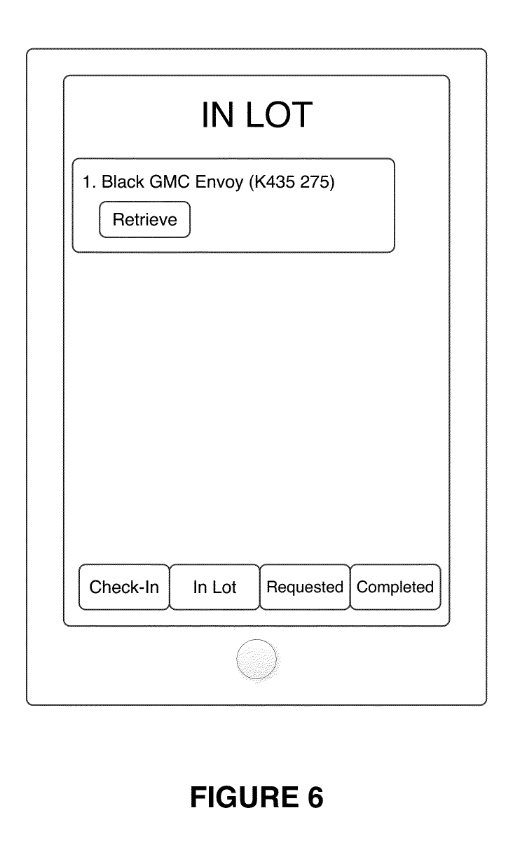

FIG. 6 shows one such example of an in-lot queue as displayed on a VPS device. As shown, the in-lot queue includes a single entry, which indicates that only one vehicle (e.g., a Black GMC Envoy) is currently parked in the VPS's parking lot. Other examples are also possible.

### VIII. Example VPS Management Operations

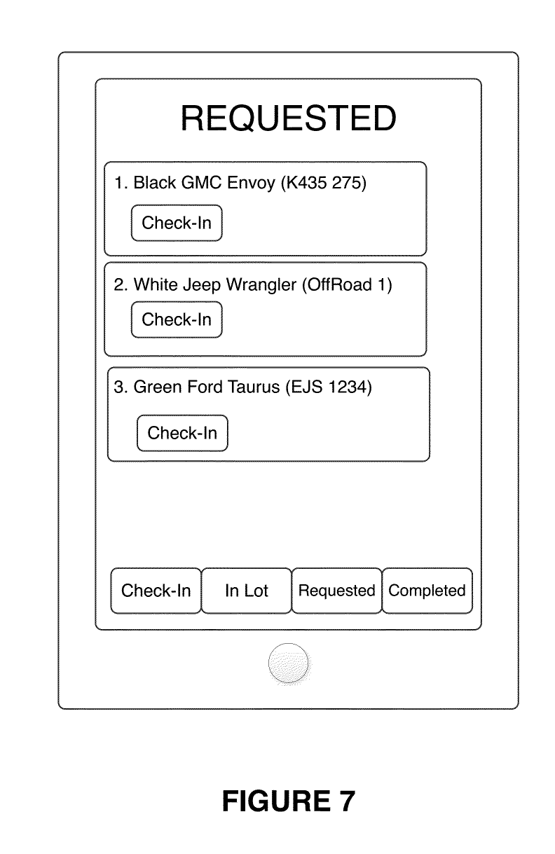

FIG. 7 shows an example queue of requested vehicles as displayed on a VPS device. In example embodiments, a requested queue may be populated or otherwise updated as drivers utilize their respective driver devices to request their respective vehicles. As the VPS system receives such requests, the VPS server may inform the VPS device of the requests, which may then be displayed to the parking attendant in a variety of manners, such as shown in FIG. 7.

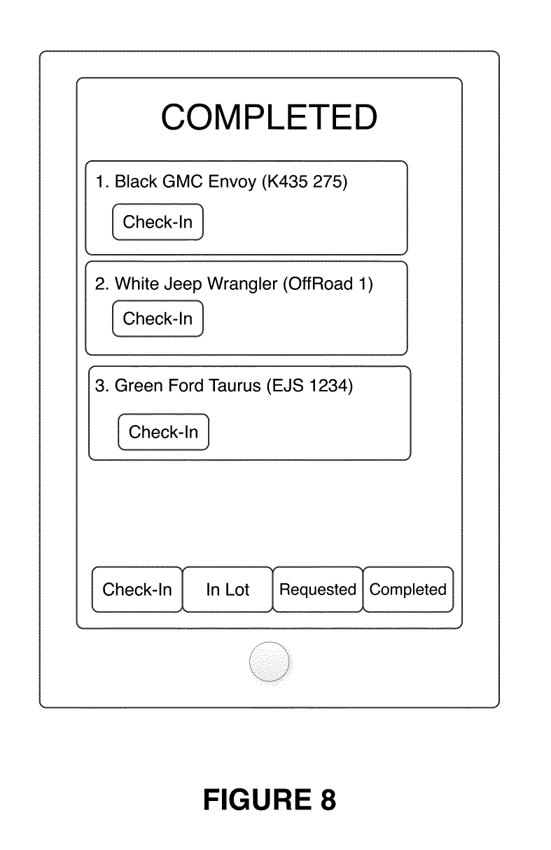

FIG. 8 shows an example queue of completed vehicles (e.g., vehicles that were returned to their respective drivers) as displayed on a VPS device. In example embodiments, a completed queue may be populated or otherwise updated as parking attendants utilize VPS devices to confirm that a vehicle has been retrieved and delivered to the vehicle's driver. As the VPS system receives such confirmations, the VPS server may relay this information to a given VPS device, which may then display a queue to the parking attendant in a variety of manners, such as shown in FIG. 8. According to certain embodiments, entries from a completed queue may expire (e.g., be removed from the queue) once a certain amount of time elapses, such as an amount of time after the time at which the vehicle was returned to the driver.

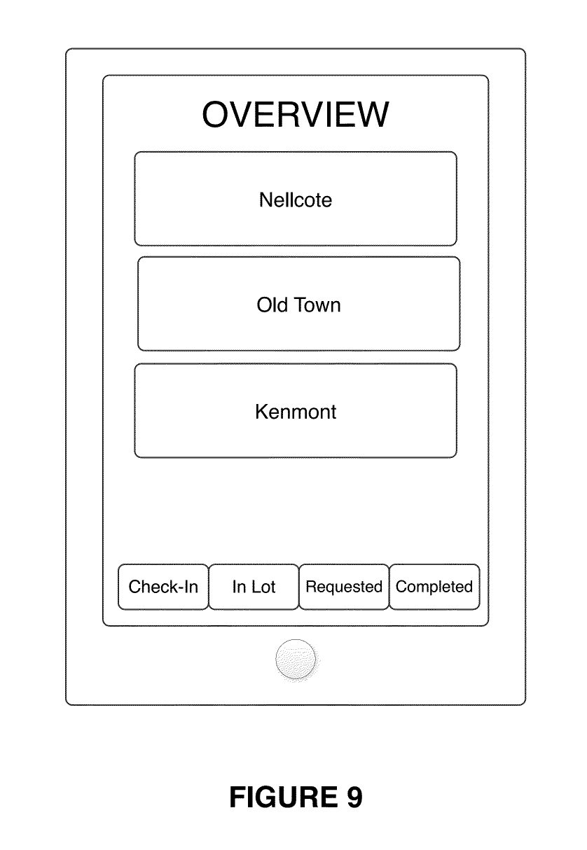

FIG. 9 shows an example a graphical user interface of a VPS management tool as displayed on a VPS device. The tool may be used for multiple VPS operations. Here, there is an operation at each of Nellcote, Old Town, and Kenmont restaurants. A given option may be selected via a VPS device to facilitate managing a particular VPS operation.

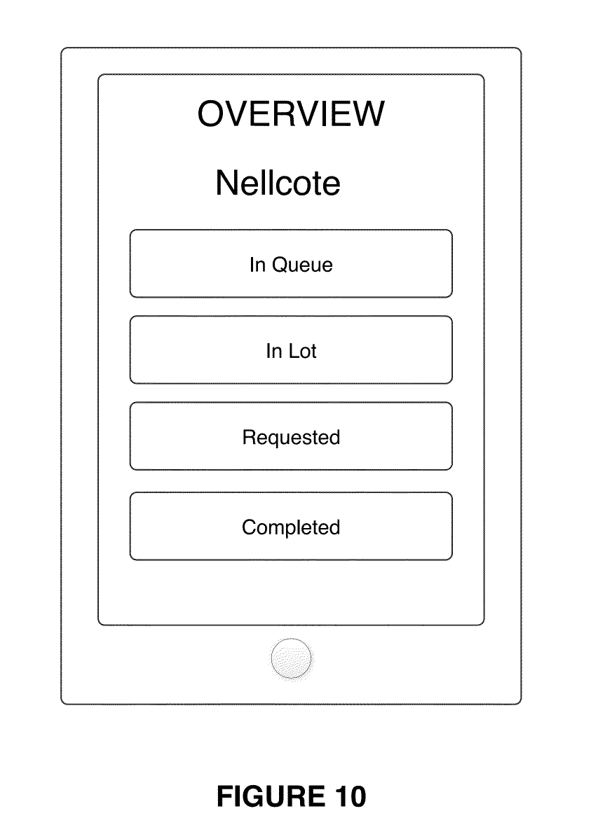

FIG. 10 shows another example graphical user interface of a VPS management tool that may have resulted from selecting the “Nellcote” icon from the graphical user interface from FIG. 9. Here, there are a number of options displayed for the establishment, Nellcote. Each button can be selected to view respective contents. For instance, the “In Queue” icon may return a graphical representation of a to-be-parked queue (e.g., a listing of vehicles that need to be parked), the “In Lot” icon may return a graphical representation of a in-parking-lot queue (e.g., a listing of vehicles that are currently parked by the VPS), the “Requested” icon may return a graphical representation of a requested queue (e.g., a listing of vehicles that have been requested to be returned to their respective drivers), and the “Completed” icon may return a graphical representation of a completed queue (e.g., a listing of vehicles allows have been picked up by their respective drivers). Other examples are also possible.

As discussed above, a VPS server that is located remote from a given VPS operation may be configured to collect and maintain data (e.g., the various queues discussed above) that is displayed by VPS devices of the given VPS operation. For instance, a parking attendant may select “In Queue” from the Nellcote Overview screen causing the VPS device to request data from the VPS server. The VPS server would return data identifying the vehicles in the to-be-parked queue at Nellcote to the local VPS device. The parking attendant can then view the vehicles that are in the queue via the VPS device. Moreover, a VPS server may collect, generate, and/or maintain parking-related statistics, which may be useful to certain groups, such as VPS operators, establishments, cities or townships, or other businesses or groups.

### IX. Example Driver Device Operations

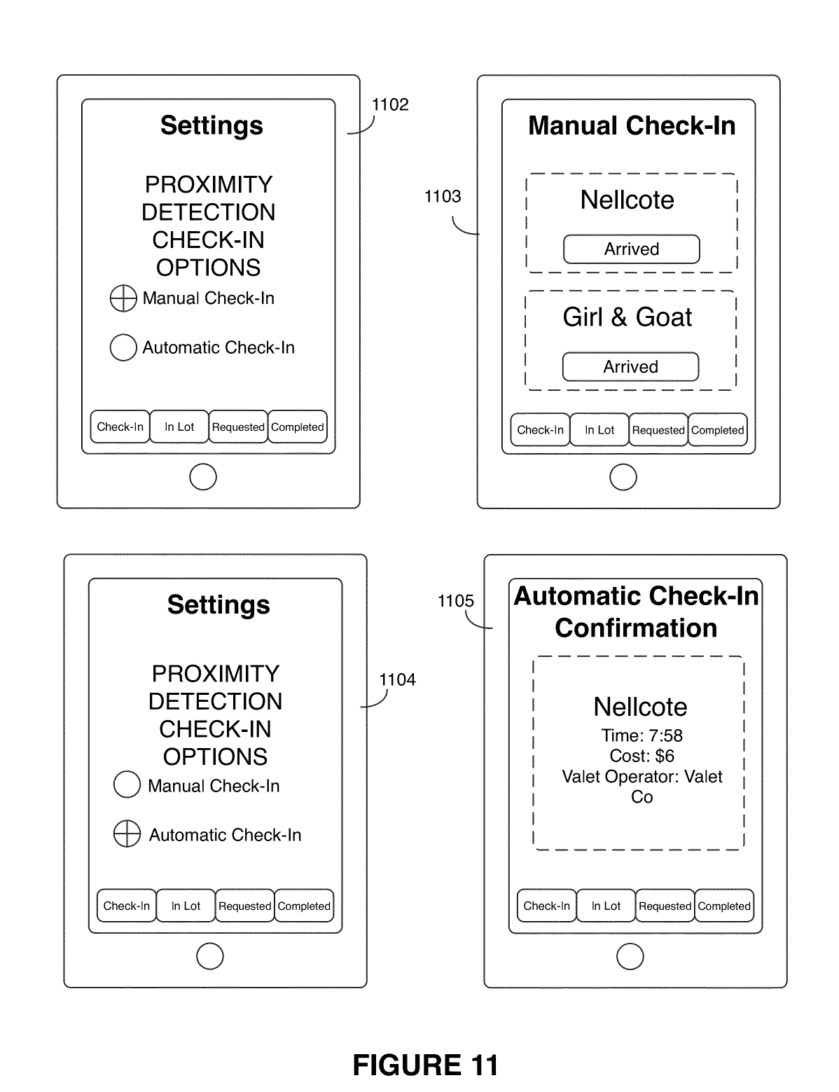

FIG. 11 shows various graphical user interfaces that a driver device might display to a driver when running a VPS application. As shown, screenshot 1102 shows an example graphical user interface where a driver may select either a manual check-in option or an automatic check-in option. A driver may decide to use manual check-in, in which case the driver may still take a paper ticket but can later request the vehicle and/or pay via the VPS application (e.g., assuming the paper ticket is converted). A user may decide to use automatic check-in. In some embodiments, automatic check-in makes it possible to not take a paper ticket. Instead, an electronic ticket can be issued. The driver may simply walk into the establishment and later request the vehicle and/or pay via the VPS application.

The screenshot 1102 shows that the manual check-in option has been selected, and screenshot 1103 shows icons that may allow the driver to manually check in to a given establishment, such as Nellcote or Girl & Goat (e.g., by selecting the corresponding “Arrived” icon). Screenshot 1104 shows that the automatic check-in option has been selected, and screenshot 1105 shows a check-in confirmation that may be sent to the driver device once automatic check-in is completed.

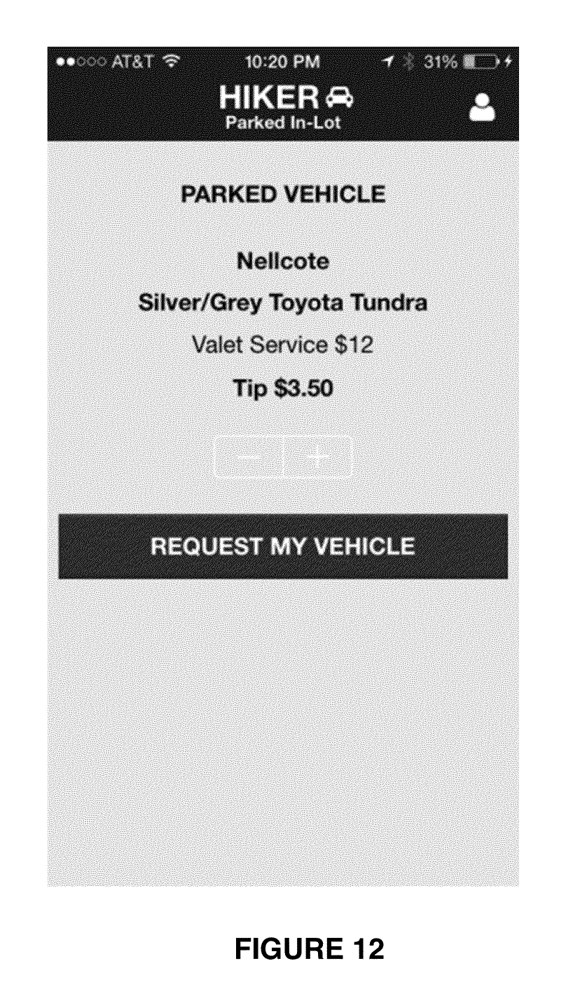

FIG. 12 shows a screenshot of a graphical user interface of a driver device in accordance with an embodiment. When a driver wishes to pay for the VPS, he or she can navigate to a window such as shown in FIG. 12. In practice, the VPS server 170 provides the information displayed on the driver device. As shown, the driver device might display details about the restaurant (e.g., the restaurant name “Nellcote”), the vehicle (e.g., “Silver/Grey Toyota Tundra”), the cost of valet parking service (e.g., $12), and the tip amount (e.g., “$3.50”). Other information may also be provided such as details about the VPS, phone numbers, or other types of relevant information. The tip amount may be adjusted up or down using the “+/−” icons displayed by the graphical interface. Furthermore, the driver may request his or her vehicle by selecting the “Request My Vehicle” icon. In example embodiments, upon pressing the icon to request the vehicle, the driver device sends to the VPS server 170 a message indicating payment information in addition to a request to get the corresponding vehicle. The VPS server 170 may then relay the request to the VPS device 120. Moreover, the VPS server 170 may also communicate with an electronic-payment system (e.g., the payment system 140) to facilitate processing the payment transaction for the driver device 110. In this way, the VPS system may facilitate the payment transaction without additional input from the driver.

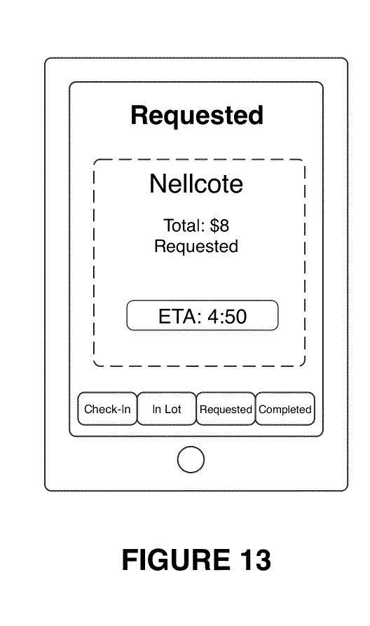

FIG. 13 shows a graphical user interface that a driver device might display after the driver has requested his or her vehicle (e.g., after the driver selected the “Request My Car” icon from FIG. 12). As shown, the driver device may display the estimated time of arrival (“ETA”) of the driver's vehicle. Here, the screen shows that the vehicle will arrive in about 4 minutes and 50 seconds. In example embodiments, the VPS system may determine ETAs by using data analysis, such as based on the number of vehicles ahead of the currently requested vehicle, historical ETA durations, average amount of time it takes to retrieve a vehicle, etc., as discussed above.

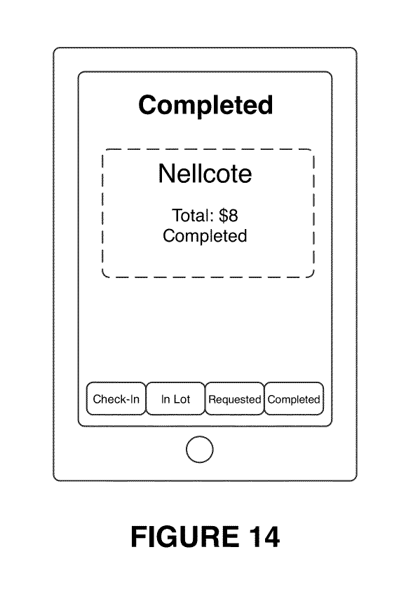

FIG. 14 shows a graphical user interface that a driver device might display after the driver's vehicle has been returned to the driver. In some embodiments, such a screen might be displayed after the later of the driver's vehicle being returned or the electronic payment transaction completing. Other examples are also possible.

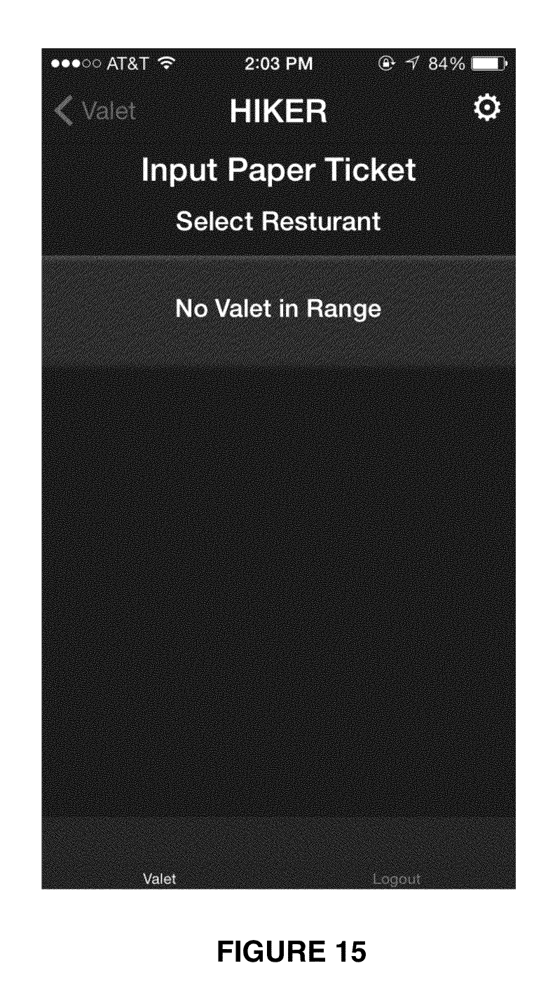

FIG. 15 shows another screenshot of a graphical user interface that a driver device might display when running a VPS application. The graphical user interface of FIG. 15 might be displayed when the driver device is not within proximity of a VPS.

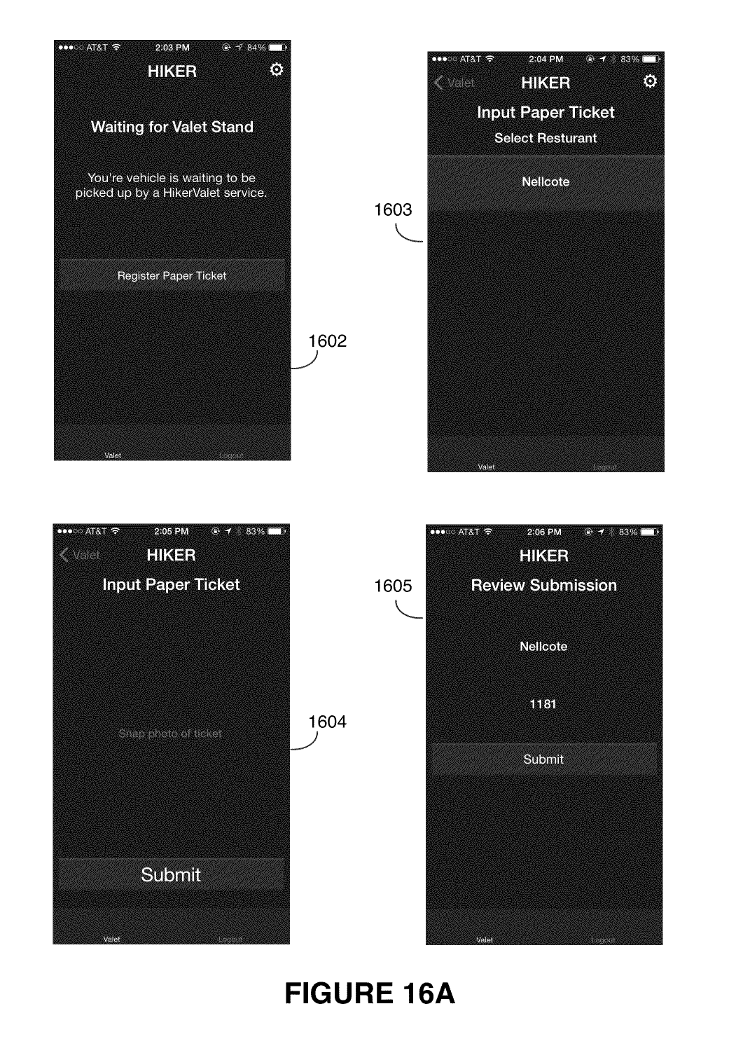

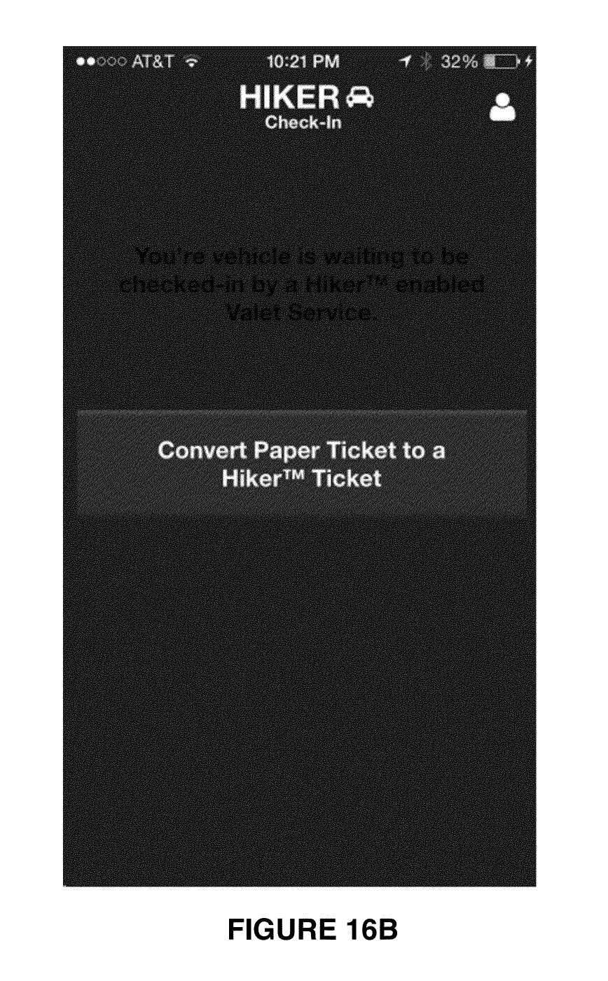

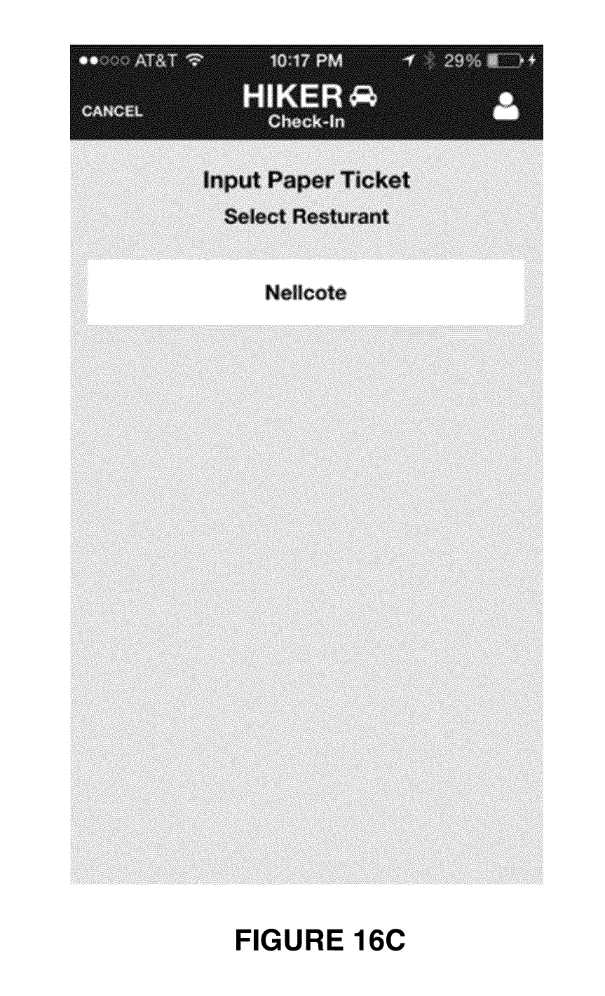

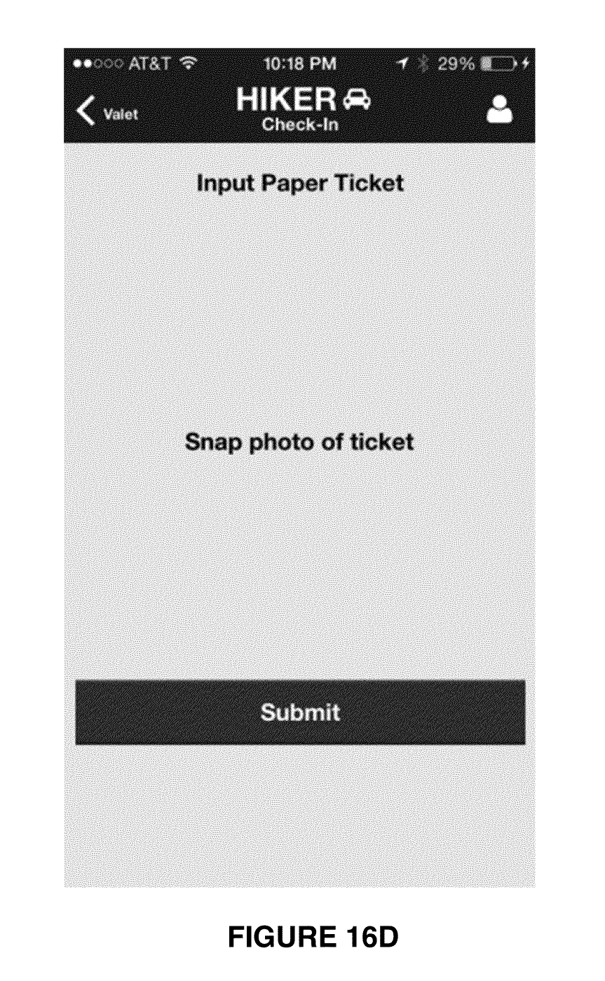

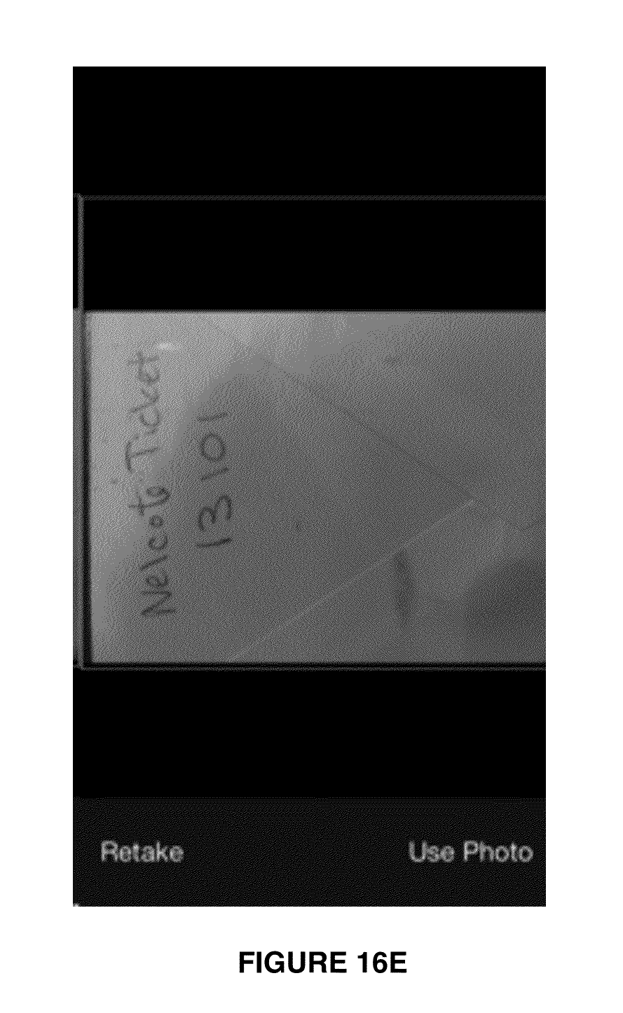

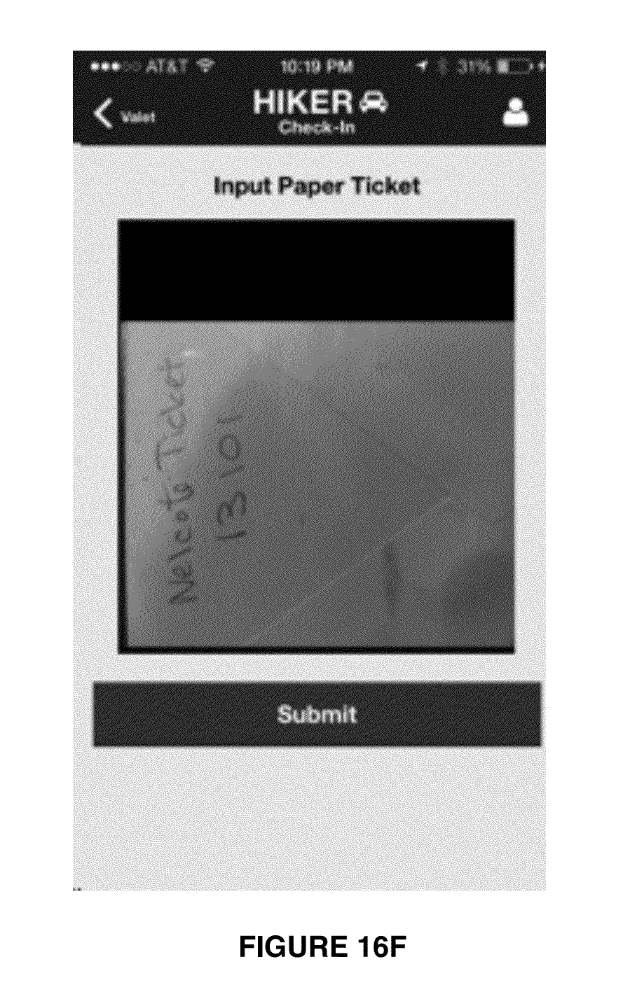

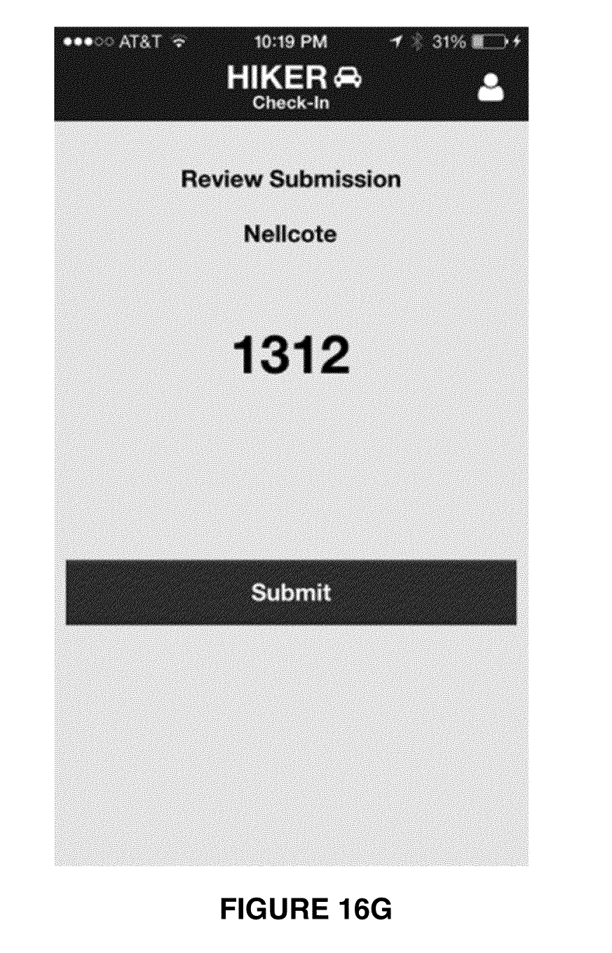

FIG. 16A shows various screenshots that may be displayed on a driver device to facilitate the process by which a paper ticket is registered (e.g., converted into an electronic ticket). As noted above, the VPS system allows a driver to use the VPS without taking a paper ticket. However, there may be times when a driver (with, or without, a driver device 110) takes a paper ticket. In example embodiments, the VPS system enables converting a paper ticket to an electronic ticket. For example, the driver uses the driver device 110 to take a picture of the paper ticket, the driver device 110 sends a copy of the picture to the VPS server 170, which may then return to the driver device 110 an electronic ticket with a new identifier (e.g., different from that on the paper ticket). After the conversion is complete, the VPS Server 170 stores a copy of the picture taken of the paper ticket, which may be retrieved by the driver device 110 and/or the VPS device 120, among other devices.

In some cases, before the VPS server 170 returns to the driver device 110 the electronic ticket, the VPS server 170 may verify whether or not the picture is adequate (and even if the image shows a paper ticket). In the event that the picture is inadequate (e.g., blurry, not of a paper ticket, etc.), the VPS server 170 might send a message to the driver device 110 requesting a new picture.

In some embodiments, once the conversion is complete, the paper ticket may no longer be valid for vehicle pick-up. That is, a parking attendant might not accept the paper ticket. Instead, the attendant might see via VPS device 120 that the paper ticket formerly assigned to the vehicle has been replaced with an electronic ticket. The driver would then show the attendant the electronic ticket via the driver device 110 at vehicle pick-up. Further, once the paper ticket is converted, the driver device 110 may be used to pay for the VPS and/or request the vehicle electronically via the VPS app.

As shown in screenshot 1602, the driver may select the “Register Paper Ticket” icon to start the process by which a paper ticket is converted to an electronic ticket. To do so, the user may select this icon. Then, at screenshot 1603, the driver may select an establishment that the driver device is in range of (e.g., “Nellcote”) to register the paper ticket with. As shown in screenshot 1604, the driver may capture a photo of the paper ticket (e.g., by pressing the “Submit” icon once the paper ticket is within the camera's sights), which may then be sent to the VPS system. Lastly, as shown in screenshot 1605, a final submission screen of the paper ticket and an electronically generated identifier (e.g., “1181”) may be presented to the driver.

FIGS. 16B-16G show another series of screenshots that may be displayed on a driver device to facilitate the process by which a paper ticket is registered. Notably, FIG. 16E shows a screenshot of the driver device when a paper ticket is within the sights of the camera of the driver device, while FIG. 16F shows a screenshot of the driver device after an image has been captured by the driver device.

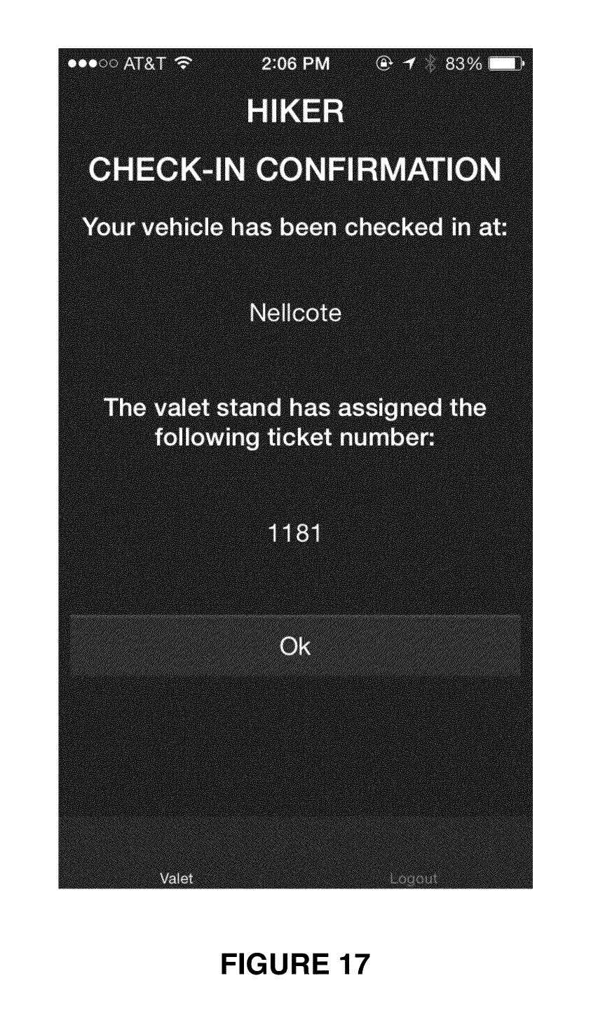

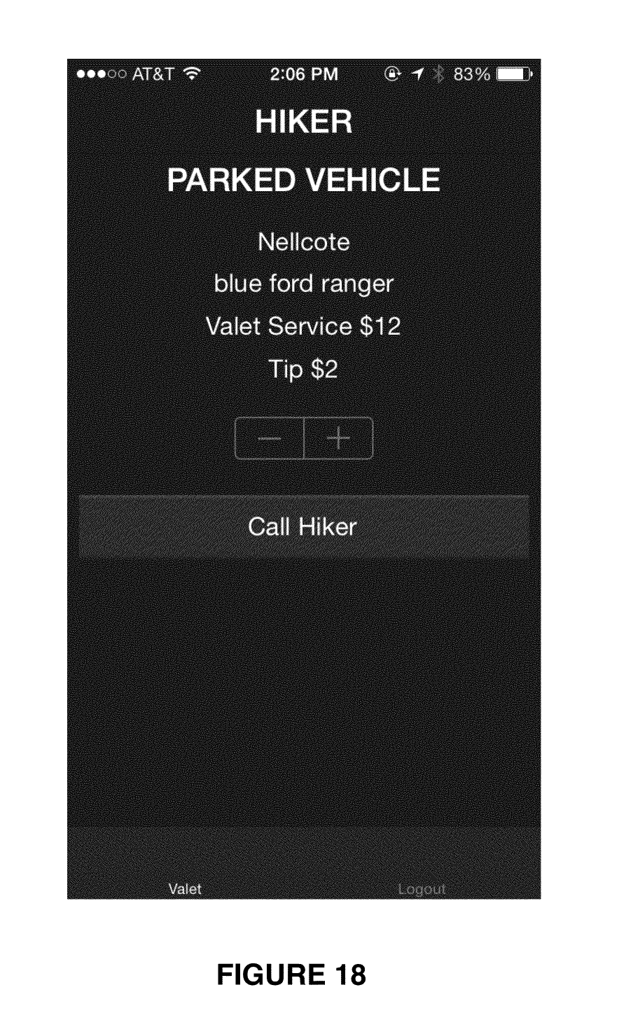

FIG. 17 shows a check-in confirmation that may be displayed by a driver device that includes an electronically generated identifier. FIG. 18 shows a graphical user interface that allows a driver to request his or her vehicle, pay for the VPS, and perhaps add a tip to the final VPS payment.

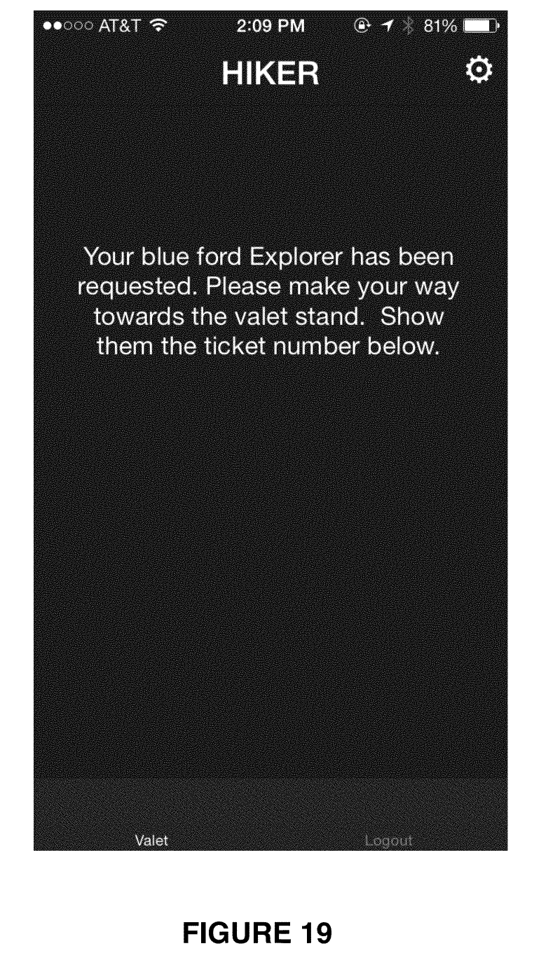

FIG. 19 shows a screenshot of a graphical interface of a driver device in accordance with an embodiment. Such a screenshot might be displayed once electronic payment and/or a vehicle request is submitted. For example, the driver device 110 may display this based on a message from the VPS server 170 confirming that the VPS system has received the driver's request for his or her vehicle.

In some cases, the driver device 110 may display further information, such as an estimated time of vehicle arrival, so that the driver has a more complete understanding of when the vehicle will arrive. As noted herein, the VPS server 170 may analyze various vehicle return times based on historical, logged times, to determine an ETA, and then provide an indication of the determined ETA to the driver device 110. Other examples are also possible.

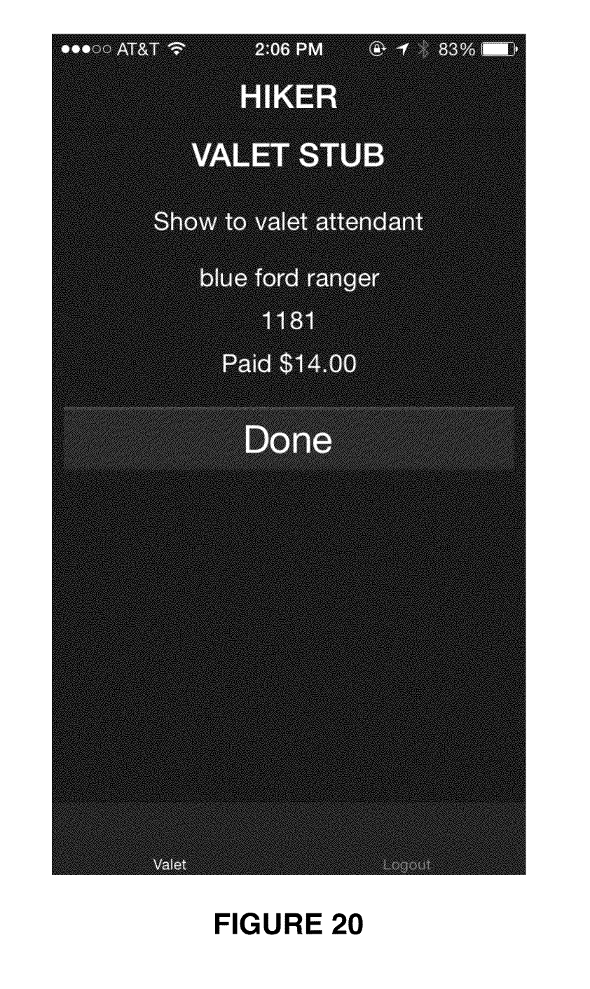

FIG. 20 shows another example graphical user interface that may be displayed by a driver device. The driver may show the display as shown in FIG. 20 to the parking attendant to verify that the vehicle is indeed the driver's vehicle.

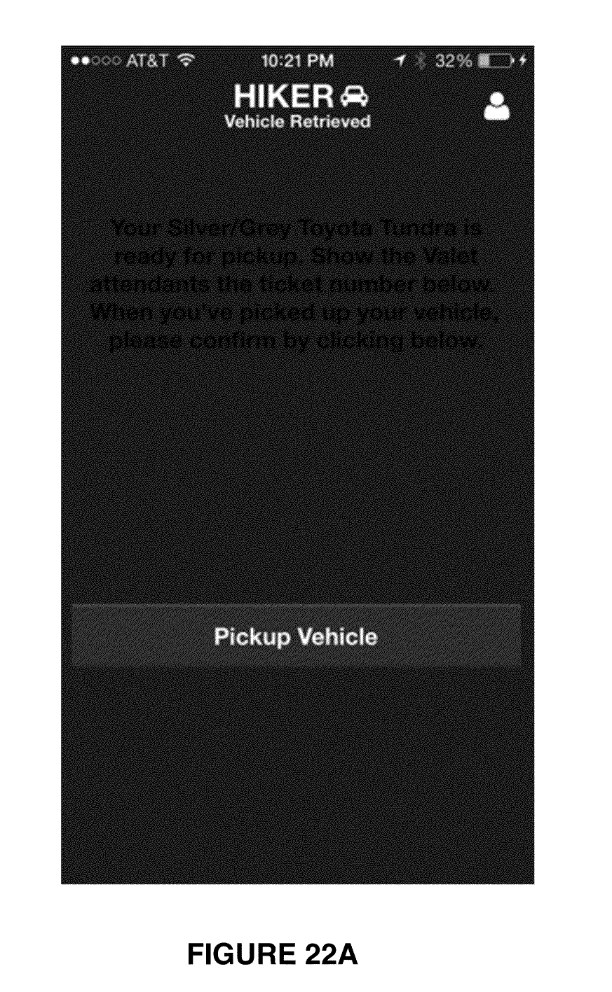

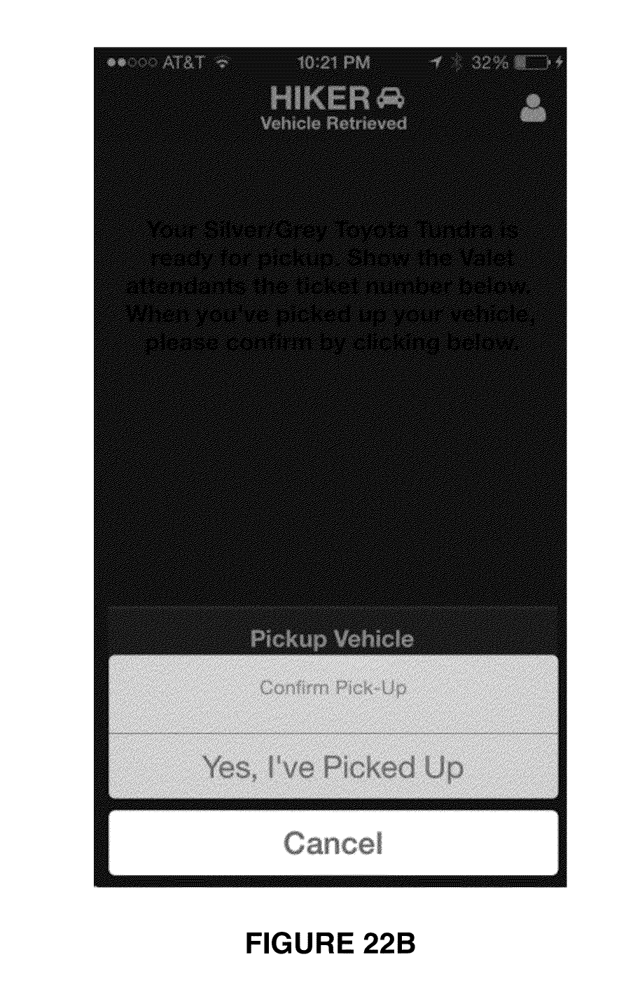

FIGS. 22A and 22B show example screenshots of a graphical user interface of a driver device in accordance with an embodiment. When the vehicle is ready to be returned to its driver, the VPS server 170 may send to the driver device 110 a message indicating that the driver's vehicle is ready for pick-up, which may be displayed as shown in FIG. 22A. In some embodiments, the driver device 110 might also display the electronic ticket and/or identifier assigned to the driver device 110 and corresponding vehicle, so that the drive can show the identifier to the parking attendant before driving away. In some cases, after the vehicle has been picked up (or in the hands of the driver), the driver may select the “Pickup Vehicle” icon from FIG. 22A to indicate that the vehicle is with the driver. Moreover, the driver may confirm the pickup by selecting the “Yes, I've Picked Up” icon that is displayed in FIG. 22B.

### X. Exemplary Interactions with an Establishment System

As mentioned above, an establishment system such as the establishment system 130 of FIG. 1 may be a system that an establishment uses to manage operations, such as, for example, reservations, customer notes and/or requests (e.g., allergies, window table), table assignments, payments, customer contact information, or other establishment operations. This section describes some exemplary embodiments of the interaction between a driver device, a VPS system, and an establishment system 130 as pertaining to establishment reservations.

When a customer makes a reservation with an establishment, information is obtained by the establishment system 130 about the customer. In addition to the user information required to hold a reservation, the customer may be asked if they are planning to valet their vehicle during their visit. At some time prior to arriving at the establishment, the user may notify the establishment system 130 that they are planning to valet their vehicle during their visit to the establishment.

In an embodiment, the establishment system 130 notifies a VPS device (possibly through an intermediary system, such as a VPS server) that a user with a reservation at the establishment is planning to valet a vehicle. In addition to user information (including, for example, vehicle information, payment information, etc.), the VPS device may obtain the time of the reservation and/or an expected arrival time (e.g., 15 minutes prior to reservation, etc.) of the vehicle. The VPS system may then use this information, for example, to plan for parking arrivals. The VPS system may then provide VPS parking attendants, via VPS devices, information ahead of time that allows the attendants to better handle arriving vehciles.

### XI. Additional Example Embodiments

In example embodiments, the VPS system described herein, or some aspect thereof, may be used in industries where offering integration to a service like vehicle parking may further enhance the experience of those industries' customers. By way of illustration, a customer may utilize a traditional reservation service (e.g., OpenTable) in the following manner: (1) a customer makes a reservation, for example, via an OpenTable software application, (2) the customer (and perhaps others) arrives at the restaurant around the reservation time, (3) the customer verbally informs someone at the host stand of the arrival, and (4) the customer waits to be seated. Generally speaking, the experience for a customer of a traditional reservation service ends after the reservation is first made, which might be days or months prior to the actual event. Moreover, the traditional reservation services currently do not facilitate vehicle parking as part of the offered customer experience.

With the VPS system described herein, or some aspect thereof, the overall experience of a reservation service customer may be effectively expanded and improved. By way of example, the VPS system may detect that a driver device (e.g., a customer in her vehicle) is approaching a restaurant and notify a reservation service computing system (e.g., an OpenTable system). The reservation service system may then provide a notice to a restaurant system (e.g., a computer at the host stand) of the arriving driver and may even check-in the driver, if so desired, which all may occur without any input from the driver (e.g., no conversation with a hostess informing of the driver's arrival and/or no interaction with the driver's smart phone).

Moreover, the parking attendant, host, or other establishment greeter may, for example, greet the driver by name, given that customer information may be made available via the VPS system. Later, the driver may request her vehicle and pay for the VPS using the VPS software application on the driver's device. As such, the traditional reservation service experience may be expanded from the beginning of the event (e.g., locating the VPS and dropping the vehicle off to parking attendant) to the end of the event (e.g., picking up her vehicle from the VPS). This, and more, may be accomplished by integrating some or all of the VPS system disclosed herein with a reservation service, such as OpenTable or the like.

The VPS system described herein, or some aspect thereof, may be used in other industries, like hotels, hospitals, apartment buildings, and airports, to name a few, where parking services are provided to its customers. In some cases, a VPS system may be set up for single events, daily service, or the like. By way of illustration, hotels traditionally offer valet parking that requires the hotel guest to use a telephone to dial a number and verbally request the vehicle. In some instances, texting may replace the traditional phone call. However, neither option provides the ease of use and overall experience that may be provided by the VPS system described herein.

For instance, a hotel might find the technology described herein useful to manage its VPSs. Guests may conveniently use their mobile computing devices to request his or her vehicle during a stay at the hotel. The hotel parking service operation may efficiently manage the requests using VPS devices, for instance.

In addition, the hotel front desk may be alerted when a guest is at the curbside of the hotel. For instance, as the guest drives up to the VPS offered by the hotel, a hotel system may receive a message from a VPS server indicating that the guest has arrived at the hotel. Check-in services may be automated based on such arrival. Room assignment and electronic key to the rooms may be provided automatically and based upon such arrival. In some cases, a VPS server (or some other system) may determine the room assignment (e.g., room number) for the particular guest and send room assignment information to the guest's mobile device (e.g., driver device). Moreover, the VPS server may be configured to provide the mobile device an electronic room key (or room credentials) that is operable to allow the guest to enter his or her room. In this way, the guest may simply walk directly to the room without having to go to the front desk. Payment of the room, VPS, and other services may be performed via the mobile device as well. Numerous other applications of the VPS technology discussed herein are also possible and contemplated herein.

### XII. Conclusion

The VPS technology disclosed herein may help provide a more modern, efficient, and/or convenient parking experience for customers. For instance, the technology may allow for “e-drop off” (electronic vehicle drop off) where there are no paper tickets, a personal greeting to drivers, and other “white glove” treatment. Further, the technology may allow for “e-payment” (electronic payment via a mobile computing device) where one can pay for the VPS at the table, bar, or anywhere else convenient. Additionally, the platform may allow for “e-retrieval” (electronic vehicle retrieval) where one can request the vehicle from his or her mobile device, and even receive notification when the vehicle is ready. From the perspective of VPS owners and/or employees, the technology may allow for vehicle tracking, inventory management, and reporting. It may help reduce the number of cash transactions, and it may also help eliminate or reduce customers waiting at a parking stand for their vehicles. The VPS technology disclosed herein may provide various other advantageous.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

Additionally, some examples described herein may refer to functions performed by given actors, such as “users,” “drivers,” “parking attendants,” and/or other entities. It should be understood that this is for purposes of explanation only. The claims should not be interpreted to require action by any such actor unless explicitly required by the language of the claims themselves.

Additionally, references herein to “embodiment” means that a particular feature, structure, or characteristic described in connection with the embodiment can be included in at least one example embodiment of an invention. The appearances of this phrase in various places in this disclosure are not necessarily all referring to the same embodiment, nor are separate or alternative embodiments mutually exclusive of other embodiments. As such, the embodiments described herein, explicitly and implicitly understood by one skilled in the art, can be combined with other embodiments

This disclosure is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

1. A computing system comprising:
a network interface configured to facilitate wireless communication with a computing device associated with a vehicle;
one or more processors;
a non-transitory computer-readable medium; and
program instructions stored on the non-transitory computer-readable medium that are executable by the one or more processors to cause the computing system to:
determine that the computing device associated with the vehicle is within a threshold proximity of a vehicle-parking service;
based at least on the determining, add a vehicle identifier corresponding to the computing device associated with the vehicle to a parking queue, wherein the parking queue comprises one or more vehicle identifiers corresponding to respective vehicles that are to be parked via the vehicle-parking service;
transmit, via the network interface to a computing device of the vehicle-parking service, data representing the parking queue; and
based on receiving an indication that the vehicle has been parked, remove the vehicle identifier from the parking queue.

2. The computing system of claim 1, wherein determining that the computing device associated with the vehicle is within a threshold proximity of a vehicle-parking service is based on (i) a location of the computing device associated with the vehicle and (ii) a location of the vehicle-parking service.

3. The computing system of claim 2, wherein the location of the vehicle-parking service comprises a location of the computing device of the vehicle-parking service.

4. The computing system of claim 2, wherein the location of the vehicle-parking service comprises a location of an establishment affiliated with the vehicle-parking service.

5. The computing system of claim 1, wherein determining that the computing device associated with the vehicle is within a threshold proximity of a vehicle-parking service comprises receiving, from the computing device of the vehicle-parking service, an indication that the computing device associated with the vehicle is within the threshold proximity of the vehicle-parking service.

6. The computing system of claim 1, wherein adding the vehicle identifier corresponding to the computing device associated with the vehicle to the parking queue is based further on an amount of time the computing device associated with the vehicle has been within the threshold proximity of the vehicle-parking service.

7. The computing system of claim 1, wherein the program instructions stored on the non-transitory computer-readable medium are further executable by the one or more processors to cause the computing system to:
receive, from the computing device associated with the vehicle, a request for the vehicle to be retrieved; and
based on receiving the request, transmit, to the computing device of the vehicle-parking service, an instruction for the vehicle to be retrieved.

8. The computing system of claim 1, wherein the program instructions stored on the non-transitory computer-readable medium are further executable by the one or more processors to cause the computing system to:
based on receiving an indication that the vehicle has been checked-in, generate an electronic parking ticket for the vehicle, wherein the vehicle parking ticket comprises the vehicle identifier; and
transmit the electronic parking ticket to at least one of the computing device associated with the vehicle or the computing device of the vehicle-parking service.

9. The computing system of claim 1, wherein the program instructions stored on the non-transitory computer-readable medium are further executable by the one or more processors to cause the computing system to:
after removing the vehicle identifier from the parking queue, add the vehicle identifier to an in-lot queue, wherein the in-lot queue comprises one or more vehicle identifiers corresponding to respective vehicles that are parked in a parking lot affiliated with the vehicle-parking service.

10. A computing device of a vehicle-parking service, the computing device comprising:
at least one network interface, wherein the at least one network interface is configured to facilitate wireless communication with a computing system associated with the vehicle-parking service;
a graphical user interface;
one or more processors;
a non-transitory computer-readable medium; and
program instructions stored on the non-transitory computer-readable medium that are executable by the one or more processors to cause the computing device to:
determine that a computing device associated with a vehicle is within proximity of the vehicle-parking service;
cause the graphical user interface to display a graphical indicator corresponding to the vehicle; and
based on detecting, via the graphical user interface, a selection of the graphical indicator, transmit to the computing system an indication that the vehicle has been parked.

11. The computing device of claim 10, wherein the at least one network interface is a first network interface, and wherein the computing device further comprises a second network interface that differs from the first network interface.

12. The computing device of claim 11, wherein determining that the computing device associated with the vehicle is within proximity of the vehicle-parking service comprises receiving, via the second network interface from the computing device associated with the vehicle, an indication of a location of the computing device associated with the vehicle.

13. The computing device of claim 11, wherein determining that the computing device associated with the vehicle is within proximity of the vehicle-parking service comprises receiving, via the first network interface from the computing system, an indication that the computing device associated with the vehicle is within the threshold proximity of the vehicle-parking service.

14. The computing device of claim 10, wherein determining that the computing device associated with the vehicle is within proximity of the vehicle-parking service is based on (i) a location of the computing device associated with the vehicle and (ii) a location of the computing device of the vehicle-parking service.

15. The computing device of claim 10, wherein the program instructions stored on the non-transitory computer-readable medium are further executable by the one or more processors to cause the computing device to:
before causing the user interface to display the graphical indicator corresponding to the vehicle, receive from the computing system data representing a parking queue, wherein the parking queue comprises one or more vehicle identifiers corresponding to respective vehicles that are to be parked via the vehicle-parking service; and
cause the graphical user interface to display a representation of the parking queue, wherein the representation of the parking queue comprises the graphical indicator corresponding to the vehicle.

16. The computing device of claim 10, wherein the program instructions stored on the non-transitory computer-readable medium are further executable by the one or more processors to cause the computing device to:
after transmitting the indication that the vehicle has been parked, receive via the at least one network interface, a request to retrieve the vehicle; and
cause the graphical user interface to display a representation of the request.

17. A non-transitory computer-readable medium comprising program instructions stored thereon that are executable to cause a computing system to:
determine that a computing device associated with a vehicle is within a threshold proximity of a vehicle-parking service;
based at least on the determining, add a vehicle identifier corresponding to the computing device associated with the vehicle to a parking queue, wherein the parking queue comprises one or more vehicle identifiers corresponding to respective vehicles that are to be parked via the vehicle-parking service;
transmit, via a network interface to a computing device of the vehicle-parking service, data representing the parking queue; and
based on receiving an indication that the vehicle has been parked, remove the vehicle identifier from the parking queue.

18. The non-transitory computer-readable medium of claim 17, wherein determining that the computing device associated with the vehicle is within a threshold proximity of a vehicle-parking service is based on (i) a location of the computing device associated with the vehicle and (ii) a location of the vehicle-parking service.

19. The non-transitory computer-readable medium of claim 17, wherein adding the vehicle identifier corresponding to the computing device associated with the vehicle to the parking queue is based further on an amount of time the computing device associated with the vehicle has been within the threshold proximity of the vehicle-parking service.

20. The non-transitory computer-readable medium of claim 17, wherein the program instructions are further executable to cause the computing system to:
receive, from the computing device associated with the vehicle, a request for the vehicle to be retrieved; and
based on the request, communicate with an electronic-payment system to facilitate processing a payment transaction for the computing device associated with the vehicle.
